(19) United States
(12) Patent Application Publication
(10) Pub. No.: US 2018/0368457 A1
(43) Pub. Date: Dec. 27, 2018

(54) Food and Beverage Products Comprising Low Calorie, Low Glycemic Index (GI), and Sustained Energy Release Sugar Composition

(71) Applicant: Petiva Private Limited, Hyderabad, Telangana (IN)

(72) Inventors: Banibrata Pandey, Hyderabad, Telangana (IN); Rahul Raju Kanumuru, Hyderabad, Telangana (IN); Sibnath Ray, Hyderabad, Telangana (IN); Biplab Bhattacharyya, Hyderabad (IN)

(21) Appl. No.: 16/062,042

(22) PCT Filed: Nov. 12, 2016
(86) PCT No.: PCT/IB2016/056828

§ 371 Date: Jun. 13, 2018

(30) Foreign Application Priority Data
Nov. 12, 2015 (IN) 2416/CHE/2015
Nov. 12, 2015 (IN) 2417/CHE/2015

(51) Int. Cl. A23L 33/125; A21D 13/062; A21D 2/18; A23C 19/076; A23G 1/40; A23G 3/42; A23G 9/34; A23L 2/60; A23L 27/30; A23L 33/20; A23L 7/126

(52) U.S. Cl. CPC A23L 33/125; A21D 13/062; A21D 2/181; A23C 19/0765; A23G 1/40; A23V 2002/00; A23G 9/34; A23L 2/60; A23L 27/33; A23L 33/20; A23L 7/126; A23G 3/42

(57) ABSTRACT

The present invention provides a low calorie, low glycemic index (GI), and sustained energy release sugar composition comprising a combination of isomaltulose, trehalulose and D-allulose; at least one of the following: essential trace elements, soluble oligosaccharides and bulking agents; and optionally, one or more nutritive sweetener for use in a food and beverage product.

This application claims the benefit of Indian provisional application number 2416/CHE/2015, filed on Nov. 12, 2015 and Indian provisional application number 2417/CHE/2015, filed on Nov. 12, 2015; which hereby incorporated by reference.

### FIELD OF THE INVENTION

The present invention relates to low calorie, low glycemic index (GI), and sustained energy release sugar composition which is suitable for use in food and beverage products.

### BACKGROUND OF THE INVENTION

Excess intake of nutritive sweeteners, such as sucrose (generally referred to as ‘sugar’ or ‘table sugar’), glucose, fructose, corn syrup, high fructose corn syrup and the like, has long been associated with an increase in diet-related health issues, such as obesity, cardiovascular disease, metabolic disorders and dental problems. Because of these consumers tend to reduce the level of nutritive sweeteners in their diet. In view of this growing need, the market has been flooded with possible candidates to replace conventional nutritive sweeteners. Unfortunately, however, many of the low or zero calorie replacements offered on the market lack one or all the necessary characteristics, and often exhibit bitterness or off-taste. Therefore, many of the proposed sweeteners are not an ideal replacement for nutritive sweeteners.

Further, consumption of foods and beverages with high content of sugars may cause the increase of blood glucose. A high level of blood glucose can lead to unwanted physiological situations for the human body and furthermore, it may provoke a disease. The natural body response towards blood glucose increase is insulin secretion from the pancreas. Insulin restores the normal level of glucose in the blood. However, the human body, due to metabolic disorders, is not always able to restore glucose levels to normal levels and this is known as metabolic syndrome. This is due to the following reasons:

a) lack of insulin secretion caused by the destruction of beta cells in the pancreas. This phenomenon is known as diabetes mellitus type I.
b) inadequate secretion of insulin from the pancreas and/or reduced sensitivity of cells to insulin (insulin resistance). In this case, the cells of the human body cannot bind glucose, which continues to circulate in the blood. This phenomenon is known as diabetes mellitus type II.

The Glycemic Index (GI) is a grading system of carbohydrate-containing foods, according to their effect to the postprandial blood sugar levels. It is defined as the ratio of the area under the blood sugar response curve over 2 hours after ingestion of a constant amount of food (usually a 50 g carbohydrate portion) divided by the area under the response curve of a reference food (usually glucose or white bread). The foods based on GI are classified as having low GI when GI is less than 55, as medium GI when GI is between 56-69 and as high GI when GI is more than 70.

Nutrition based on a low GI has been increasingly recommended in recent years, with a view to its adoption in diets contributing to health and in particular to the glycemic control of people with diabetes (postprandial hyperglycemia reduction, thus lower average blood sugar levels). According to American Diabetics Association (ADA) in combination with carbohydrate counting, the GI may provide an additional benefit for achieving blood glucose goals.

Therefore, there is a desire to provide low calorie, low glycemic index (GI), and sustained energy release sugar composition which is suitable for use in food and beverage products.

### SUMMARY OF THE INVENTION

In one aspect, the present invention relates to low calorie, low glycemic index (GI), and sustained energy release sugar composition comprising:
a combination of sugars selected from a group comprising isomaltulose, trehalulose and D-allulose;
at least one of the following: essential trace elements, soluble oligosaccharides and bulking agents; and
optionally, one or more nutritive sweetener.

In another aspect, the present invention relates to low calorie, low glycemic index (GI), and sustained energy release sugar composition which is suitable for use in food and beverage products.

In yet another aspect, the present invention relates to a composition comprising:
(a) a low calorie, a low glycemic index, and sustained energy release sugar composition comprising a combination of sugars selected from a group comprising isomaltulose, trehalulose and allulose;
(b) at least one of the following: essential trace elements, soluble oligosaccharides and bulking agents;
(c) optionally, one or more nutritive sweetener; and
(d) an edible component;
wherein the edible component is a food and beverage and the sugars are present in a combined total amount of from about 5% to about 80% by weight relative to the total weight of the composition.

In yet another aspect, the present invention relates to a food and beverage product comprising:
a combination of sugars selected from a group comprising isomaltulose, trehalulose and D-allulose;
at least one of the following: essential trace elements, soluble oligosaccharides and bulking agents; and
optionally, one or more nutritive sweetener;
wherein the sugars are present in a combined total amount of from about 5% to about 80% by weight relative to the total weight of the food and beverage product.

Before the methods of the present disclosure are described in greater detail, it is to be understood that the methods are not limited to particular embodiments described, as such may, of course, vary. It is also to be understood that the terminology used herein is for the purpose of describing particular embodiments only, and is not intended to be limiting, since the scope of the methods will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the methods. The upper and lower limits of these smaller ranges may independently be included in the smaller ranges and are also encompassed within the methods, subject to any specifically excluded limit in the stated range. Where the stated range includes one or both of the limits, ranges excluding either or both of those included limits are also included in the methods.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which the methods belong. Although any methods similar or equivalent to those described herein can also be used in the practice or testing of the methods, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present methods are not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

It is appreciated that certain features of the methods, which are, for clarity, described in the context of separate embodiments, may also be provided in combination in a single embodiment. Conversely, various features of the methods, which are, for brevity, described in the context of a single embodiment, may also be provided separately or in any suitable sub-combination. All combinations of the embodiments are specifically embraced by the present invention and are disclosed herein just as if each and every combination was individually and explicitly disclosed, to the extent that such combinations embrace operable processes and/or devices/systems/kits. In addition, all sub-combinations listed in the embodiments describing such variables are also specifically embraced by the present methods and are disclosed herein just as if each and every such sub-combination was individually and explicitly disclosed herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present methods. Any recited method can be carried out in the order of events recited or in any other order which is logically possible.

### DETAILED DESCRIPTION OF THE INVENTION

In one embodiment, the present invention provides a low calorie, low glycemic index (GI), and sustained energy release sugar composition comprising:
a combination of sugars selected from a group comprising isomaltulose, trehalulose and D-allulose;
at least one of the following: essential trace elements, soluble oligosaccharides and bulking agents; and
optionally, one or more nutritive sweetener.

### D-Allulose:

D-Psicose (D-allulose, D-ribo-2-hexulose, and C₆H₁₂O₆) is a low-energy monosaccharide sugar present in small quantities in natural products. First identified in wheat more than 70 years ago, psicose is a C-3 epimer of D-fructose, and is present in small quantities in agricultural products and commercially prepared carbohydrate complexes. The sweetness of psicose is 70% of the sweetness of sucrose, high solubility clean taste, smooth texture, and desirable mouth feel, no calories and a low glycemic index.

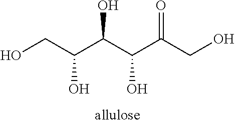 [SMILES: O=C(CO)[C@H](O)[C@H](O)[C@H](O)CO]

Studies reveal that approximately 98% of intravenously administered allulose is excreted in the urine within 6 hours of treatment. After oral administration of allulose, urinary excretion of unchanged allulose ranged from 11 to 25%. This indicates that allulose absorbed in the small intestine may pass into the bloodstream and be excreted in the urine, without significant metabolism.

Unless stated otherwise, the allulose used in the present invention is D-allulose.

### Isomaltulose:

Isomaltulose is a disaccharide carbohydrate with a very low GI and can be used in the production of carbohydrate-based foods with low or reduced blood glucose response.

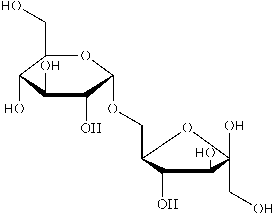

The sweetness profile of isomaltulose is similar to sucrose without any after taste. Its sweetening power in 10% solution is 0.18 related to sucrose. Isomaltulose reported to mask the of-flovor of some intense sweetener. Compared with sugar, it exhibits a slight cooling effect.

Isomaltulose has low hygroscopicity. No significant water pick-up takes place at a storage temperature at 25° C. and a relative humidity (RH) of approximately 85%. Therefore, isomaltulose is ideal for moisture sensitive applications such as chocolate and in blends with other hygroscopic ingredients it functions as an anti-caking agent. Isomaltulose is reducing sugar is subjected to Millard reaction.

### Trehalulose:

The common name of the notified substance is or 1-O-α-D-glucopyranosyl-β-D-fructofuranose, is more soluble in water than its structural isomers sucrose, thus the consequence of its use as food ingredients is different. This reducing disaccharide that is naturally present in small quantities in honey. This natural sugar has a sweet taste and has very similar physical and organoleptic properties to sucrose. It is highly hygroscopic substance and has a melting point of 48° C. Specifically, trehalulose has about 60% of the sweetness of sucrose. However, compared to sucrose or glucose, it is less glycemic, less insulinemic and is non-cariogenic as the linkage between glucose and fructose is more stable than in sucrose thus the sugar is hydrolyzed slowly but completely and absorbed by the small intestine. It is a reducing disaccharide consisting of one glucose and one fructose moiety linked by an alpha-1, 1-glycosidic bond.

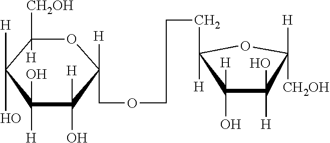

In another embodiment, the present invention provides low calorie, low glycemic index, and sustained energy release sugar composition comprise two sugars selected from isomaltulose, trehalulose and allulose. In certain embodiments, the two sugars are isomaltulose and trehalulose. In certain embodiments, the ratio of the isomaltulose to the trehalulose is from about 14:1 to about 1:1 on a weight to weight basis. In certain embodiments, the ratio is from about 10:1 to about 1:1 or from about 5:1 to about 1:1 or from about 2:1 to about 1:1.

In certain embodiments, the low calorie, low glycemic index, and sustained energy release sugar composition comprise trehalulose and allulose, wherein the ratio of the allulose to the trehalulose is from about 0.4:1 to about 17:1 on a weight to weight basis. In certain embodiments, the ratio is from about 0.3:1 to about 10:1 or from about 0.2:1 to about 5:1 or from about 0.1:1 to about 3:1

In certain embodiments, the low calorie, low glycemic index, and sustained energy release sugar composition comprise isomaltulose and allulose, wherein the ratio of the allulose to the isomaltulose is from about 0.19:1 to about 17:1 on a weight to weight basis. In certain embodiments, the ratio is from about 0.17:1 to about 15:1 or 0.15:1 to about 10:1 or 0.13:1 to about 5:1 or from about 0.1:1 to about 1:1.

In certain embodiments, the present invention provides a low calorie, low glycemic index, and sustained energy release sugar composition comprising isomaltulose, trehalulose and allulose; wherein the ratio of the isomaltulose to the trehalulose is from about 14:1 to about 1:1; allulose to the trehalulose is from about 0.4:1 to about 17:1, and allulose to the trehalulose is from about 0.19:1 to about 17:1 on a weight to weight basis.

In certain embodiments, the essential trace element is present in an amount of from about 0.01% to about 1% by weight relative to the total weight of the composition. In certain embodiments, the soluble oligosaccharides are present in an amount of from about 0.01% to about 1% by weight relative to the total weight of the composition.

In certain embodiments, the nutritive sweetener is selected from a group comprising sucrose and invert sugar.

In certain embodiments, the present invention provides a composition comprising:
a low calorie, a low glycemic index, and sustained energy release sugar composition comprising a combination of sugars selected from a group comprising isomaltulose, trehalulose and allulose;
at least one of the following: essential trace elements, soluble oligosaccharides and bulking agents;
optionally, one or more nutritive sweetener;
and an edible component;
wherein the edible component is a food and beverage and the sugars are present in a combined total amount of from about 5% to about 80% by weight relative to the total weight of the composition. In certain embodiments, the low calorie, low glycemic index, and sustained energy release sugar composition comprises two sugars selected from isomaltulose, trehalulose and allulose in a combined total amount of from about 5% to about 80% by weight relative to the total weight of the composition. In certain embodiments, the essential trace element is present in an amount of from about 0.01% to about 1% and soluble oligosaccharides are present in an amount of from about 0.01% to about 1% by weight relative to the total weight of the composition. In certain embodiments, the nutritive sweetener is selected from a group comprising sucrose and invert sugar,

In certain embodiments, the present invention provides a food and beverage product comprising:
a combination of sugars selected from a group comprising isomaltulose, trehalulose and D-allulose;
at least one of the following: essential trace elements, soluble oligosaccharides and bulking agents; and
optionally, one or more nutritive sweetener;
wherein the sugars are present in a combined total amount of from about 5% to about 80% by weight relative to the total weight of the food and beverage product.

In certain embodiments, the food and beverage products may include two sugars selected from a group comprising isomaltulose, trehalulose and D-allulose in a combined total amount of up to about 80% by weight relative to the total weight of the food and beverage product, for example in an amount of from about 5% by weight to about 80% by weight relative to the total weight of the food and beverage product. In another embodiment, the amount of rare sugars is from about 7.5% to about 75% or from about 10% to about 70% or from about 12.5% to about 65% or from about 15% to about 60% or from about 17.5% to about 55% or from about 20% to about 50% or from about 22.5% to about 45% or from about 25% to about 40% or from about 27.5% to about 35%. All intermediate amounts (i.e. 2%, 3%, 4% . . . 77%, 78%, 79% by weight relative to the total weight of the food and beverage product) are contemplated, as are all intermediate ranges based on these amounts.

In yet another embodiment, the food and beverage products may include isomaltulose and trehalulose, wherein the ratio of the isomaltulose to the trehalulose is from about 14:1 to about 1:1 on a weight to weight basis. In yet another embodiment the ratio is from about 10:1 to about 1:1, from about 5:1 to about 1:1 or from about 2:1 to about 1:1.

In yet another embodiment, the food and beverage products may include trehalulose and allulose, wherein the ratio of the allulose to the trehalulose is from about 0.4:1 to about 17:1 on a weight to weight basis. In another embodiment, the ratio is from about 0.3:1 to about 10:1 or from about 0.2:1 to about 5:1 or from about 0.1:1 to about 3:1.

In yet another embodiment, the food and beverage products may include isomaltulose and allulose, wherein the ratio of the allulose to the isomaltulose is from about 0.19:1 to about 17:1 on a weight to weight basis. In another embodiment, the ratio is from about 0.17:1 to about 15:1 or 0.15:1 to about 10:1 or 0.13:1 to about 5:1 or from about 0.1:1 to about 1:1.

Food and beverage products according to the present invention include baked goods; sweet bakery products (including, but not limited to, rolls, cakes, pies, pastries, and cookies); pre-made sweet bakery mixes for preparing sweet bakery products; pie fillings and other sweet fillings (including, but not limited to, fruit pie fillings and nut pie fillings such as pecan pie filling, as well as fillings for cakes, cookies, pastries, confectionary products and the like, such as fat-based cream fillings); gelatins, desserts, and puddings; frozen desserts (including, but not limited to, frozen dairy desserts such as ice cream—including regular ice cream, soft serve ice cream and all other types of ice cream—and frozen non-dairy desserts such as non-dairy ice cream, sorbet and the like); carbonated beverages (including, but not limited to, soft carbonated beverages); non-carbonated beverages (including, but not limited to, soft non-carbonated beverages such as flavored waters and sweet tea or coffee based beverages); beverage concentrates (including, but not limited to, liquid concentrates and syrups as well as non-liquid ‘concentrates’, such as freeze-dried and/or powder preparations); yogurts (including, but not limited to, full fat, reduced fat and fat-free dairy yogurts, as well non-dairy and lactose-free yogurts and frozen equivalents of all of these); snack bars (including, but not limited to, nut, cereal, seed and/or fruit bars); bread products (including, but not limited to, leavened and unleavened breads, yeasted and unyeasted breads such as soda breads, breads comprising any type of wheat flour, breads comprising any type of non-wheat flour (such as rice, potato and rye flours), gluten-free breads); pre-made bread mixes for preparing bread products; sauces, syrups and dressings; sweet spreads (including, but not limited to, jellies, jams, butters, nut spreads and other spreadable preserves, conserves and the like); confectionary products (including, but not limited to, soft candies, jelly candies, hard candies, gums and chocolates); sweetened breakfast cereals (including, but not limited to, extruded (kix type) breakfast cereals, flaked breakfast cereals and puffed breakfast cereals); and cereal coating compositions for use in preparing sweetened breakfast cereals. Other types of food and beverage products not mentioned here but which conventionally include one or more nutritive sweetener may also be contemplated in the context of the present invention. In particular, animal foods (such as pet foods) are explicitly contemplated.

As a consequence of the complete or partial replacement of nutritive sweeteners in the food and beverage products of the present invention, the food and beverage products of the present invention may be useful as low calorie or dietetic products, medical foods/products (including, but not limited to tablets, pills, syrups and elixirs), and sports nutrition products.

In one embodiment, the present invention provides a bread product comprising and isomaltulose in an amount of from about 0% to about 30%, trehalulose in an amount of from about 0% to about 30% and allulose in an amount of from about 0% to about 30% by weight relative to the total weight of the uncooked bread product (e.g. uncooked bread dough); wherein isomaltulose, trehalulose and D-allulose are not 0% simultaneously. In yet another embodiment, isomaltulose may present in an amount of from about 2% to about 20%, trehalulose may present in an amount of from about 2% to about 20% and D-allulose may present in an amount of from about 3% to about 30% by weight relative to the total weight of the yogurt. In certain embodiments, the bread product may further comprise at least one soluble oligosaccharide in an amount from about 0.1% to about 1%, at least one essential trace element in an amount from about 0.02% to about 0.05% by weight relative to the total weight of the uncooked product and, optionally, one or more nutritive sweetener.

Any type of bread product may be contemplated, including leavened and unleavened breads, yeasted and unyeasted breads (such as soda breads), breads comprising any type of wheat flour, breads comprising any type of non-wheat flour (such as rice, potato, and rye flours), gluten-free breads, and any other types of bread.

The bread product according to the present invention may include one or more ingredients selected from the group consisting of vegetables and vegetable-derived products (such as vegetable shortening), leavening agents (such as yeast, bicarbonate of soda, baking soda, cream of tartar and the like), eggs or egg-derived products, fats, oils, water, milk and/or other dairy products, alcohol, gums, natural and/or artificial colors, natural and/or artificial flavors (such as vanilla), salt, chocolate and/or cocoa, coconut and coconut-derived products, spices, fruits and fruit-derived products, legumes and legume-derived products, nuts and nut-derived products, preservatives, additives, stabilizers, antioxidants, emulsifiers, proteins, amino acids, vitamins, minerals, and any other ingredients suitable for inclusion in a bread product.

Optimization of certain physical properties of the bread products according to the present invention may be done by making certain adjustments to the conventional recipes, besides the complete or partial replacement of nutritive sweeteners (such as sucrose, high fructose corn syrup and the like) by the combination of isomaltulose and trehalulose. The physical properties desired to optimize include crumb structure, level of browning, moisture retention (humectancy), and the like.

By way of example, a bread according to the present invention may comprise the following ingredients:

Sweet Bread/Bun/Roll

| Ingredient | Amount, % (w/w) |
|---|---|
| Allulose | 0-30 |
| Isomaltulose | 0-30 |
| Trehalulose | 0-30 |
| Isomaltooligosaccharide | 0-1 |
| Invert sugar | 0-30 |
| Bread flour | 30-50 |
| Table salt | 0.2-0.95 |
| Essential trace element | 0.02-0.05 |
| (Zn, Fe) | |
| Powder Milk | 0.0-2.0 |
| Vegetable oil | 0.0-2.0 |
| Di-acyl glycerol | 0.5-1.0 |
| Potasium bisulphite | 0.01-0.02 |
| Water | 15-30 |
| Total | 100 |

In another embodiment, the present invention provides a confectionary product comprising isomaltulose in an amount from 0% to about 75%, trehalulose in an amount of from about 0% to about 75% and allulose in an amount of from about 0% to about 75% by weight relative to the total weight of the uncooked confectionary product; wherein isomaltulose, trehalulose and allulose are not 0% simultaneously. In certain embodiments, the isomaltulose may present in an amount of from about 15% to about 25%, trehalulose may present in an amount of from about 0% to about 25% and allulose may present in an amount of from about 0% to about 45% by weight relative to the total weight of the uncooked confectionary product. In certain embodiments, the confectionary product may further comprise at least one soluble oligosaccharide in an amount from about 0.01% to about 1% by weight relative to the total weight of the product and, optionally, one or more nutritive sweetener

Confectionary products which may be contemplated include, but are not limited to, jelly candies, soft candies (such as non-chocolate candies, plain chocolate candies such as chocolate bars and chocolate coated candies), hard candies (including pressed candy mints), chocolate and gums (such as chewing gums and the like). The confectionary products according to the present invention may include one or more other ingredients selected from the group consisting of leavening agents (such as baking soda, cream of tartar and the like), bulking agents, fats, oils, water, milk and/or other dairy products, gums, alcohol, natural and/or artificial colors, natural and/or artificial flavors, spices, salt, fruits and fruit-derived products, vegetables and vegetable-derived products, legumes and legume-derived products, nuts and nut-derived products, stabilizers, preservatives, antioxidants, emulsifiers, proteins, amino acids, acidulants, minerals, vitamins, and any other ingredients suitable for inclusion in a confectionary product.

By way of example, a gelatin gummy candy according to the present invention may comprise the following ingredients:

Ingredient of Gelatin gummy candy

| Ingredient | Amount, % (w/w) |
|---|---|
| Invert sugar | 0-75 |
| Sucrose | 0-75 |
| D-allulose | 0-75 |
| Isomaltulose | 0-75 |
| Trehalulose | 0-75 |
| Isomaltooligosaccharide | 0-1 |
| Pectin | 0-5 |
| Citric acid 50% | 0.5-2 |
| Flavour | 0.2-0.5 |
| Coating agent | 0.1-0.2 |
| water | 0-100 |
| Total | 100 |

In certain embodiments, the present invention provides a non-carbonated beverage comprising low calorie, low glycemic index, and sustained energy release sugar composition comprising isomaltulose in an amount from about 0% to about 15%, trehalulose in an amount from about 0% to about 15% and trehalulose in an amount of from about 0% to about 15% by weight relative to the total weight of the beverage; wherein isomaltulose, trehalulose and D-allulose are not 0% simultaneously. In certain embodiments, isomaltulose may present in an amount from about 0% to about 10%, trehalulose may present in an amount from about 0% to about 10% and allulose may present in an amount of from about 2% to about 10% by weight relative to the total weight of the beverage. In certain embodiments, the non-carbonated beverage may further comprise at least oligosaccharide in an amount of from about 0.1% to about 1.0% by weight relative to the total weight of the beverage and, optionally, one or more nutritive sweetener

Any type of non-carbonated beverage may be contemplated, but non-alcoholic (i.e. soft) non-carbonated beverages are generally preferred. In addition to allulose, the non-carbonated beverage according to the present invention comprises a non-carbonated liquid. The non-carbonated liquid may comprise water, tea, milk, coffee, vegetable and/or fruit and/or legume juices, purees and/or extracts, or any other non-carbonated liquid used in the preparation of non-carbonated beverages.

Examples of non-carbonated beverages according to the present invention include flavored waters, fruit drinks (e.g. strawberry), sweet tea or coffee based beverages, and sports nutrition drinks (such as protein shakes, electrolyte drinks and the like) recovery drinks and health drinks.

The non-carbonated beverages according to the present invention may include one or more ingredients selected from the group consisting of gums, natural and/or artificial colors, natural and/or artificial flavors, acidulants, salt, electrolytes, spices, fats, oils, fruits and fruit-derived products, nuts and nut-derived products, milk and dairy products, vegetables and vegetable-derived products, legumes and legume-derived products, preservatives, stabilizers, antioxidants, vitamins, minerals, protein (including whey protein and the like), amino acids, herbs and herbal extracts, coffee and coffee extracts, tea and tea extracts, and any other ingredients suitable for inclusion in a non-carbonated beverage. When an acidulant is used in the non-carbonated beverage product, it may be based on organic and/or inorganic acids and may be one or more selected from the group consisting of acetic acid, citric acid, phosphoric acid, lactic acid, malic acid, fumaric acid, ascorbic acid, as well as any other acidulants suitable for inclusion in a non-carbonated beverage.

In yet another embodiment, the non-carbonated beverage is not an alcoholic or beer-flavored beverage.

By way of example, flavored water according to the present invention may comprise the following ingredients:

Flavored water

| Ingredient | Amount, % (w/w) |
|---|---|
| Allulose | 0.0-15.0 |
| Isomaltulose | 0.0-15.0 |
| Trehalulose | 0.0-15.0 |
| Isomaltooligosaccharide | 0.3-1.0 |
| Invert Sugar | 0.0-5.0 |
| Potassium Citrate | 0.03 |
| Citric acid, fine | 0.1-0.2 |
| Flavor | 0.1 |
| Essential trace element | 0.02-0.05 |
| Water | 0-100 |
| Total | 100 |

In certain embodiments, the present invention provides a carbonated beverage comprising low calorie, low glycemic index, and sustained energy release sugar composition comprising isomaltulose in an amount of from about 0% to about 70%, trehalulose in an amount of from about 0% to about 70% and D-allulose in an amount of from about 0% to about 70% by weight relative to the total weight of carbonated beverage; wherein isomaltulose, trehalulose and D-allulose are not 0% simultaneously. In certain embodiments, the isomaltulose may present in an amount of from about 0% to about 25%, trehalulose may present in an amount of from about 0% to about 25% and D-allulose may present in an amount of from about 10% to about 50% by weight relative to the total weight of the carbonated beverage. In certain embodiments, the carbonated beverage may further comprise at least one soluble oligosaccharide in an amount from about 0.1% to about 1% % by weight relative to the total weight of the carbonated beverage and, optionally, one or more nutritive sweetener. In certain embodiments, the carbonated beverage is preferably a non-alcoholic carbonated beverage.

By way of example, carbonated beverage according to the present invention may comprise the following ingredients:

Carbonated Beverage

| Ingredient | Amount, % (w/w) |
|---|---|
| Invert sugar | 0-70 |
| D-allulose | 0-70 |
| Isomaltulose | 0-70 |
| Trehalulose | 0-70 |
| Isomaltooligosaccharide | 0-1 |
| Citric Acid | 0.1-0.2 |
| Flavor | 0.2-0.5 |
| Sodium Citrate | 0.1-0.2 |
| Sodium Benzoate | 0.1-0.2 |
| Water | 0-100 |

In yet another embodiment, the present invention provides a frozen dessert comprising comprising low calorie, low glycemic index, and sustained energy release sugar composition comprising isomaltulose in an amount of from about 0% to about 30%, trehalulose in an amount of from about 0% to about 30% and allulose in an amount of from about 0% to about 30% by weight relative to the total weight of the dessert; wherein isomaltulose, trehalulose and allulose are not 0% simultaneously. In certain embodiments, the isomaltulose may present in an amount of from about 0% to about 20%, trehalulose may present in an amount of from about 0% to about 20% and allulose may present in an amount of from about 2% to about 20% by weight relative to the total weight of the dessert. In certain embodiments, the frozen dessert may further comprise at least one soluble oligosaccharide in an amount from about 0.01% to about 1% by weight relative to the total weight of the dessert and, optionally, one or more nutritive sweetener.

Frozen desserts which may be contemplated include, but are not limited to, frozen dairy desserts such as ice cream (including regular ice cream, soft serve ice cream and all other types of ice cream) and frozen non-dairy desserts such as non-dairy ice cream, sorbet and the like. The frozen dessert of the present invention may further comprise one or more milk products (in the case of ice-creams, for example). Said milk products may be derived from the milk of any animal (including but not limited to water buffalo, cow, goat, sheep and camel), or may be a plant-derived ‘milk’ such as soy milk, coconut milk or nut milks such as almond milk. The milk products include creams, butters, milk solids, as well as dry powders, such as milk powder. In certain embodiments, some or all of the milk products used have reduced or zero fat content.

The frozen dessert according to the present invention may include one or more ingredients selected from the group consisting of eggs or egg-derived products, fats, oils, water, dairy products, alcohol, gums, natural and/or artificial colors, natural and/or artificial flavors (such as vanilla), salt, chocolate and/or cocoa, coconut and coconut-derived products, spices, fruits and fruit-derived products, vegetables and vegetable-derived products, legumes and legume-derived products, nuts and nut-derived products, acidulants, preservatives, stabilizers (for example mixtures comprising one or more of: Gums such as a cellulose gum; starches such as modified waxy-maize starches; dextrose; carrageenan; mono- and/or di-glycerides and disodium phosphate), minerals, vitamins, amino acids, antioxidants, proteins, and any other ingredients suitable for inclusion in a frozen dessert.

By way of example, ice-cream according to the present invention may comprise the following ingredients:

Ice Cream Formulation

| | |
|---|---|
| Serum mix | 62.54 |
| Cream + Milk | 69.57 |
| Isomaltulose | 0-30 |
| Trehalulose | 0-30 |
| Allulose | 0-30 |
| Invert sugar | 0-30 |
| Isomaltooligosaccharide | 0-1 |
| % solid | 39.64 |
| % butter fat | 12 |
| % MSNF | 10 |
| Total | 100 |

The present invention provides a table-top sweetener comprising low calorie, low glycemic index, and sustained energy release sugar composition comprising isomaltulose, trehalulose and allulose. The table-top sweetener my further comprise at least one essential trace element, and, optionally, one or more soluble oligosaccharide and nutritive sweetener.

In yet another embodiment, the present invention provides a table-top sugar comprising isomaltulose in an amount of from about 0% to about 70%, trehalulose in an amount of from about 0% to about 50% and D-allulosein an amount of from about 0% to about 85% by weight relative to the total weight of isomaltulose, trehalulose and D-allulosein the table-top sweetener; wherein isomaltulose, trehalulose and D-allulose are not 0% simultaneously. In yet another embodiment, the isomaltulose is present in an amount of from about 0% to about 70%, trehalulose is present in an amount of from about 0% to about 50% and D-allulose is present in an amount of from about 10% by weight relative to the total weight of isomaltulose, trehalulose and D-allulose in the table-top sugar. In yet another embodiment, the essential trace element(s) may present in an amount from about 0.02% to about 0.05% by weight relative to the total weight of the table-top sugar and, optionally, one or more soluble oligosaccharide and nutritive sweetener.

By way of example, table-top sugar according to the present invention may comprise the following ingredients:

Table-top Sugar

| Ingredients | Amount, % w/w |
|---|---|
| Sucrose | 0-100 |
| Allulose | 0-70 |
| Isomaltulose | 0-50 |
| Trehalulose | 0-50 |
| Invert Sugar | 0.0-10.0 |
| Isomalto-oligosaccharide | 0.0-1.0 |
| Citric acid | 0.1 |
| Essential trace element | 0.02-0.05 |
| (Ca, Zn, Fe) | |

In yet another embodiment, the present invention provides yogurt comprising low calorie, low glycemic index, and sustained energy release sugar composition comprising isomaltulose in an amount of from about 0% to about 50%, trehalulose in an amount of from about 0% to about 50% and D-allulose in an amount of from about 0% to about 50% by weight relative to the total weight of the yogurt; wherein isomaltulose, trehalulose and D-alluloseare not 0% simultaneously. In yet another embodiment, isomaltulose may present in an amount of from about 0% to about 20%, trehalulose may present in an amount of from about 0% to about 20% and D-allulose may present in an amount of from about 20% to about 30% by weight relative to the total weight of the yogurt. In certain embodiments, the yogurt may further comprise at least one soluble oligosaccharide in an amount from about 0.1% to about 1% by weight relative to the total weight of the yogurt and, optionally, one or more nutritive sweetener.

Any type of yogurt may be contemplated, including fat-free reduced fat, full fat, and dairy yogurts, as well non-dairy and lactose-free yogurts. Yogurt drinks, or ‘drinking yogurts’ are also contemplated. Dairy yogurts (i.e. true yogurts) are generally preferred. In addition to allulose, the yogurt according to the present invention comprises a yogurt base. The yogurt base may generally comprise a fermented milk product. The milk product may be derived from the milk of any animal (including but not limited to buffalo, cow, goat, and sheep), or may be a plant-derived ‘milk’ such as soy milk, coconut milk or nut milks such as almond milk. The fermented milk product is produced by fermenting the milk product using a yogurt culture.

Typically, the yogurt according to the present invention may be prepared by combining the yogurt base with a flavor preparation, such as a fruit-based flavor preparation. The yogurt according to the present invention may include one or more ingredients selected from the group consisting of gums, natural and/or artificial colors, natural and/or artificial flavors, starches, salt, spices, fruits and fruit-derived products, vegetables and vegetable-derived products, legumes and legume-derived products, nuts and nut-derived products, preservatives, stabilizers, antioxidants, vitamins, minerals and any other ingredients suitable for inclusion in a yogurt. Such ingredients may be incorporated in the yogurt base and/or in a flavor preparation.

By way of example, yogurt according to the present invention may comprise the following ingredients:

Flavored Yogurt

| Ingredients | Amount, % (w/w) |
|---|---|
| Whole Milk | 0.0-30 |
| Lactobacillus sp | 0.5-1.0 |
| D-allulose | 0-50 |
| Isomaltulose | 0-50 |
| Trehalulose | 0-50 |
| Invert Sugar | 0-30 |
| Isomaltooligosaccharide | 0.0-1.0 |
| Flavor | 0.2-0.5 |
| Food color (optional) | 0-0.1 |
| Total | 100 |

In certain embodiments, the present invention provides a sweet bakery product comprising low calorie, low glycemic index, and sustained energy release sugar composition comprising isomaltulose in an amount of from about 0% to about 40%, trehalulose in an amount of from about 0% to about 40% and D-allulose in an amount of from about 0% to about 40% by weight relative to the total weight of the uncooked product; wherein isomaltulose, trehalulose and D-allulose are not 0% simultaneously. In certain embodiments, the isomaltulose may present in an amount of from about 0% to about 20%, trehalulose may present in an amount of from about 0% to about 20% and D-allulose may present in an amount of from about 10% to about 35% by weight relative to the total weight of the uncooked product. In certain embodiments, the sweet bakery product may further comprise at least one soluble oligosaccharide in an amount from about 0.1% to about 1%, at least one essential trace element in an amount from about 0.02% to about 0.05% by weight relative to the total weight of the uncooked product and, optionally, one or more nutritive sweetener. Sweet bakery products which may be contemplated include, but are not limited to, cookies cakes, pies and pastries.

The sweet bakery product according to the present invention typically comprises one or more starchy ingredients, including all suitable types of flours (including bleached, unbleached and self-raising flours). The starchy ingredient may be derived from any suitable source including, but not limited to, wheat, rice, and maize (corn). The sweet bakery product may include one or more ingredients selected from the group consisting of leavening agents (such as yeast, bicarbonate of soda, baking soda and the like), eggs or egg-derived products, fats, oils, water, milk and/or other dairy products, alcohol, gums, natural and/or artificial colors, natural and/or artificial flavors (such as vanilla), salt, chocolate and/or cocoa, coconut and coconut-derived products, spices, fruits and fruit-derived products, vegetables and vegetable-derived products, nuts and nut-derived products, preservatives, stabilizers, antioxidants, emulsifiers, vitamins, and any other ingredients suitable for inclusion in a sweet bakery product.

To optimize certain physical properties of the sweet bakery products according to the present invention, it may be desirable to make certain other adjustments to the conventional recipes, besides the complete or partial replacement of nutritive sweeteners (such as sucrose, invert sugar and the like) with any combination of isomaltulose, trehalulose and allulose. Physical properties which it may be desired to optimize include crumb structure (e.g. of cookies, pie crusts and the like), spread (e.g. in the case of cookies), surface appearance, softness (e.g. in the case of cookies), degree of rise (e.g. in the case of cakes), level of browning, moisture retention (humectancy), and the like.

In certain embodiments, the sweet bakery product of the present invention is a cookie.

By way of example, cookie according to the present invention may comprise the following ingredients:

Cookie

| | Amount, % |
|---|---|
| Ingredients | (w/w) |
| Invert Sugar | 0-15 |
| Granulated Sugar | 0-30 |
| Allulose | 0-40 |
| isomaltulose | 0-40 |
| trehalulose | 0-40 |
| Isomaltooligosaccharide | 0-1 |
| Butter, unsalted | 15 |
| Essential trace element | 0.02-0.05 |
| (Zn, Ca, Fe) | |
| Eggs, whole, dried | 7 |
| Flavor extract | 0.2-0.5 |
| All purpose white flour | 30 |
| Baking Soda | 0.5 |
| Semi-sweet chocolate | 5 |
| chips | |
| Water | 0-30 |
| Total | 100 |

In certain embodiments, the sweet bakery product of the present invention is a cake.

By way of example, cake according to the present invention may comprise the following ingredients:

Cake

| | Amount, |
|---|---|
| Ingredients | % (w/w) |
| Allulose | 0-40 |
| Granulated sugar white | 0-40 |
| Isomaltulose | 0-40 |
| Trehalulose | 0-40 |
| Isomaltooligosaccharide | 0.2-1.0 |
| Cake flour | 10.0-30 |
| Baking Powder | 0.5-1.0 |
| Salt, iodized | 0.2-0.5 |
| Essential trace element | 0.02-0.05 |
| (Zn, Fe) | |
| Milk, whole | 10.0-20 |
| Egg, whole | 15.0-30.0 |
| Flavor extract | 0.2-1.0 |
| Butter. Unsalted | 0.0-20 |
| Total | 100 |

In certain embodiments, the present invention provides a snack bar comprising low calorie, low glycemic index, and sustained energy release sugar composition comprising isomaltulose in an amount of from about 0% to about 30%, trehalulose in an amount of from about 0% to about 30% and D-allulose in an amount of from about 0% to about 30% by weight relative to the total weight of the snack bar; wherein isomaltulose, trehalulose and D-allulose are not 0% simultaneously. In certain embodiments, isomaltulose may present in an amount of from about 0% to about 10%, trehalulose may present in an amount of from about 5% to about 10% and D-allulose may present in an amount of from about 10% to about 20% by weight relative to the total weight of the snack bar. The snack bar may further comprise at least one soluble oligosaccharide in an amount from about 0.1% to about 1%, at least one essential trace element in an amount from about 0.02% to about 0.05% % by weight relative to the total weight of the snack bar and, optionally, one or more nutritive sweetener.

The snack bar according to the present invention may include one or more ingredients selected from the group consisting of flours, fats, oils, water, salt, glycerin, dairy products, gums, natural and/or artificial colors, natural and/or artificial flavors (such as vanilla), salt, chocolate and/or cocoa, coconut and coconut-derived products, spices, fruits and fruit-derived products, vegetables and vegetable-derived products, nuts and nut-derived products, acidulants, preservatives, stabilizers, antioxidants, proteins (including whey protein and the like), amino acids, vitamins, minerals, and any other ingredients suitable for inclusion in a snack bar.

To optimize certain physical properties of the snack bars according to the present invention, it may be desirable to make certain other adjustments to the conventional recipes, besides the complete or partial replacement of nutritive sweeteners with any combination of isomaltulose, trehalulose and allulose.

By way of example, snack bar according to the present invention may comprise the following ingredients:

Snack Bar

| Ingredients | Amount, % (w/w) |
|---|---|
| Oat flour | 30-40 |
| Rice Flour | 10.0-20 |
| Raisin, pista. Almond, | 10.0-20 |
| apricot | |
| Invert sugar | 0-30 |
| Table Sugar | 0-30 |
| Allulose | 0-30 |
| Isomaltulose | 0-30 |
| Trehalulose | 0-30 |
| Isomaltooligosaccharide | 0-30 |
| Sunflower oil | 3.0-5.0 |
| Glycerin | 3.0-5.0 |
| Flavor | 0.2-0.5 |
| Table salt | 0.5-1.0 |
| Essential trace element | 0.02-0.05 |
| Water | 0-5 |

In certain embodiments, the present invention provides an Indian sweet comprising low calorie, low glycemic index, and sustained energy release sugar composition comprising isomaltulose in an amount of from about 0% to about 60%, trehalulose in an amount of from about 0% to about 60% and D-allulosein an amount of from about 0% to about 60% by weight relative to the total weight of the uncooked product; wherein isomaltulose, trehalulose and D-allulose are not 0% simultaneously. In certain, embodiments, the Indian sweet may further comprise at least one soluble oligosaccharide in an amount from about 0.1% to about 1% by weight relative to the total weight of the Indian sweet and, optionally, one or more soluble essential trace element and nutritive sweetener.

Indian sweets which may be contemplated include, but are not limited to Agra-Petha, Balushahi, Besan Laddu, Gajar Ka Halwa, Rasgulla, Jalebi, Kalakand, Kesar Pista Barfi, Malai Peda, Doodh Peda, Kaju Barfi, Ras Malai and Soan Papdi.

In certain embodiments, the present invention provides Agra-Petha comprising low calorie, low glycemic index, and sustained energy release sugar composition comprising isomaltulose in an amount of from about 0% to 40%, trehalulose in an amount of from about 0% to 40%, and D-allulose in an amount of from about 0% to 40% by weight relative to the total weight of the uncooked product; wherein isomaltulose, trehalulose and D-allulose are not 0% simultaneously. In certain embodiments, the isomaltulose may present in an amount of from about 2% to about 30%, trehalulose may present in an amount of from about 2% to about 30% and D-allulose may present in an amount of from about 2% to about 20% by weight relative to the total weight of the uncooked product; wherein isomaltulose, trehalulose and D-allulose are not 0% simultaneously. In certain, embodiments, the Agra-Petha may further comprise at least one soluble oligosaccharide in an amount from about 0.1% to about 1% by weight relative to the total weight of the Agra-Petha and, optionally, one or more soluble essential trace element in an amount from about 0.1% to 0.5% and nutritive sweetener. The Agra-Petha according to the present invention may include one or more ingredients suitable for inclusion in Agra-Petha.

By way of example, Agra-Petha according to the present invention may comprise the following ingredients:

Agra Petha

| Ingredient | Amount, % (w/w) |
|---|---|
| Sliced white pumpkin | 40-70 |
| Sucrose | 0-30 |
| Isomaltulose | 0-40 |
| Trehalulose | 0-40 |
| Allulose | 0-40 |
| Isomaltooligosaccharide | 0.1-1 |
| Lime | 0.2-1 |
| Rose water | 0.2-0.5 |
| Water | 20-30 |
| Total | 100 |

In certain embodiments, the present invention provides Balushahi comprising low calorie, low glycemic index, and sustained energy release sugar composition comprising isomaltulose in an amount of about 40%, trehalulose in an amount of about 40% and D-allulosein an amount of about 40% by weight relative to the total weight of the uncooked product; wherein isomaltulose, trehalulose and D-alluloseare not 0% simultaneously. In certain embodiments, the isomaltulose may present in an amount of from about 2% to about 15%, trehalulose may present in an amount of from about 2% to about 15% and D-allulose may present in an amount of from about 0% to about 15% by weight relative to the total weight of the uncooked product. In certain, embodiments, the Balushahi may further comprise at least one soluble oligosaccharide in an amount from about 0.1% to about 1% by weight relative to the total weight of the Balushahi and, optionally, one or more soluble essential trace element in an amount from 0.1% to 0.5% and nutritive sweetener. The Balushahi according to the present invention may include one or more ingredients suitable for inclusion in Balushahi.

By way of example, Balushahi according to the present invention may comprise the following ingredients:

Balushahi

| Ingredients | Amount, % (w/w) |
|---|---|
| Wheat Flour | 30-50 |
| Sucrose | 0-30 |
| Isomaltulose | 0-30 |
| Trehalulose | 0-30 |
| Allulose | 0-30 |
| Isomaltooligosaccharide | 0-1 |
| Butter | 5.0-10 |
| Essential trace element | 0.2-0.5 |
| (Zn, Fe, Ca) | |
| Table Salt | 1-1.5 |
| Oil (Food grade) | 30-40 |
| Water | 15-20 |
| Total | 100 |

In certain embodiments, the present invention provides Besan Laddu comprising low calorie, low glycemic index, and sustained energy release sugar composition comprising isomaltulose in an amount of from about 0% to about 40%, trehalulose in an amount of from about 0% to about 40% and D-allulosein an amount of from about 0% to about 40% by weight relative to the total weight of the uncooked product; wherein isomaltulose, trehalulose and D-allulose are not 0% simultaneously. In certain embodiments, the isomaltulose may present in an amount of from about 2% to about 20%, trehalulose may present in an amount of from about 2% to about 20% and D-allulose may present in an amount of from about 0% to about 20% by weight relative to the total weight of the uncooked product. In certain, embodiments, the Besan Laddu may further comprise at least one soluble oligosaccharide in an amount from about 0.1% to about 1% by weight relative to the total weight of the product and, optionally, one or more soluble essential trace element and nutritive sweetener. The Besan Laddu according to the present invention may include one or more ingredients suitable for inclusion in Besan Laddu.

By way of example, Besan Laddu according to the present invention may comprise the following ingredients:

Besan Laddu

| | Amount, % |
|---|---|
| Ingredients | (w/w) |
| Besan (Gram Flour) | 50-75 |
| Sucrose | 0-40 |
| Isomaltulose | 0-40 |
| Trehalulose | 0-40 |
| Allulose | 0-40 |
| Isomaltooligosaccharide | 0-1 |
| Butter/Ghee | 1.0-4 |
| Cardamom powder | 0.1-0.5 |
| Water | 15-30 |
| Total | 100 |

In certain embodiments, the present invention provides Gajar Halwa comprising low calorie, low glycemic index, and sustained energy release sugar composition comprising isomaltulose in an amount of from about 0% to 20%, trehalulose in an amount of from about 0% to 20% and D-allulose in an amount of from about 0% to 20% by weight relative to the total weight of the uncooked product; wherein isomaltulose, trehalulose and D-allulose are not 0% simultaneously. In certain embodiments, the isomaltulose may present in an amount of from about 2% to about 15%, trehalulose may present in an amount of from about 1% to about 15% and D-allulose may present in an amount of from about 0% to about 10% by weight relative to the total weight of the uncooked product; wherein isomaltulose, trehalulose and D-allulose are not 0% simultaneously. In certain, embodiments, the Gajar Halwa may further comprise at least one soluble oligosaccharide in an amount from about 0.1% to about 1% by weight relative to the total weight of the sweet and, optionally, one or more soluble essential trace element and nutritive sweetener. The Gajar Halwa according to the present invention may include one or more ingredients suitable for inclusion in Gajar Halwa.

By way of example, Gajar Halwa according to the present invention may comprise the following ingredients:

Gajar Ka Halwa

| | Amount, in % |
|---|---|
| Ingredients | (w/w) |
| Carrot Red | 40-60 |
| Pure Ghee/Butter | 0.5-2 |
| Milk (full cream) | 40-50 |
| Sucrose | 0-20 |
| Isomaltulose | 0-20 |
| Trehalulose | 0-20 |
| Allulose | 0-20 |
| Isomaltooligosaccharide | 0-1 |
| Crashed Dry fruits | 3.0-10 |
| Cardamom powder | 0-0.5 |
| Total | 100 |

In certain embodiments, the present invention provides Rasgulla comprising low calorie, low glycemic index, and sustained energy release sugar composition comprising isomaltulose in an amount of from about 0% to about 30%, trehalulose in an amount of from about 0% to about 30% and D-allulose in an amount of from about 0% to about 30% by weight relative to the total weight of the uncooked product; wherein isomaltulose, trehalulose and D-allulose are not 0% simultaneously. In certain embodiments, the isomaltulose may present in an amount of from about 0% to about 15%, trehalulose may present in an amount of from about 2% to about 30% and D-allulose may present in an amount of from about 0% to about 15% by weight relative to the total weight of the uncooked product; wherein isomaltulose, trehalulose and D-allulose are not 0% simultaneously. In certain, embodiments, the Rasgulla may further comprise at least one soluble oligosaccharide in an amount from about 0.1% to about 1% by weight relative to the total weight of the sweet and, optionally, one or more soluble essential trace element and nutritive sweetener. The Rasgulla according to the present invention may include one or more ingredients suitable for inclusion in Rasgulla.

By way of example, Rasgulla according to the present invention may comprise the following ingredients:

Ingredient of Rasgulla

| Ingredients | Amount, % (w/w) |
|---|---|
| Cottage Cheese | 70-96 |
| Sucrose | 0-30 |
| Isomaltulose | 0-30 |
| Trehalulose | 0-30 |
| Allulose | 0-30 |
| Isomaltooligosaccharide | 0-1 |
| Lemon extract | 0.2-0.5 |
| Rose Essence (optional) | 0.1-0.3 |
| Water (ml) | 100 |

In certain embodiments, the present invention provides Jalebi comprising low calorie, low glycemic index, and sustained energy release sugar composition comprising isomaltulose in an amount of from about 0% to about 60%, trehalulose in an amount of from about 0% to about 60%, and D-allulose in an amount of from about 0% to about 60% by weight relative to the total weight of the uncooked product; wherein isomaltulose, trehalulose and D-allulose are not 0% simultaneously. In certain embodiments, the isomaltulose may present in an amount of from about 10% to about 35%, trehalulose may present in an amount of from about 10% to about 35% and D-allulose may present in an amount of from about 0% to about 20% by weight relative to the total weight of the uncooked product. In certain, embodiments, the Jalebi may further comprise at least one soluble oligosaccharide in an amount from about 0.1% to about 1% by weight relative to the total weight of the sweet and, optionally, one or more soluble essential trace element and nutritive sweetener. The Jalebi according to the present invention may include one or more ingredients suitable for inclusion in Jalebi.

By way of example, Jalebi according to the present invention may comprise the following ingredients:

Jalebi (North Indian)

| Ingredients | Amount, in % (w/w) |
|---|---|
| Refine Flour/Maida | 30-70 |
| Gram Flour/Besan | 5.0-15 |
| Yogurt | 5.0-15 |
| Sucrose | 0-60 |
| Isomaltulose | 0-60 |
| Trehalulose | 0-60 |
| Allulose | 0-60 |
| Isomaltooligosaccharide | 0-1 |
| Ghee/butter for deep frying | 700 ml/kg |
| Water | 750 ml/kg |
| Total | 100 |

In certain embodiments, the present invention provides Kalakand comprising low calorie, low glycemic index, and sustained energy release sugar composition comprising isomaltulose in an amount of from about 0% to about 30%, trehalulose in an amount from about 0% to about 30% and D-allulose in an amount of from about 0% to about 30%, by weight relative to the total weight of the uncooked product; wherein isomaltulose, trehalulose and D-allulose are not 0% simultaneously. In certain embodiments, the isomaltulose may present in an amount of from about 2% to about 15%, trehalulose may present in an amount of from about 2% to about 15% and D-allulose may present in an amount of from about 0% to about 10% by weight relative to the total weight of the uncooked product. In certain, embodiments, the kalakand may further comprise at least one soluble oligosaccharide in an amount from about 0.1% to about 1% by weight relative to the total weight of the sweet and, optionally, one or more soluble essential trace element and nutritive sweetener. The Kalakand according to the present invention may include one or more ingredients suitable for inclusion in Kalakand.

By way of example, kalakand according to the present invention may comprise the following ingredients:

Kalakand

| | Amount, in |
|---|---|
| Ingredients | % (w/w) |
| Cow Milk for chena | 30-50 |
| Cow Milk | 30-50 |
| Chopped Nut | 2.0-10 |
| Citric Acid | 0.1-0.5 |
| Sucrose | 0-30 |
| Isomaltulose | 0-30 |
| Trehalulose | 0-30 |
| Allulose | 0-30 |
| Isomaltooligosaccharide | 0-1 |
| Silver foil (optional) | flake |
| Water | 4.0-10 |
| Total | 100 |

In certain embodiments, the present invention provides Kesar Pista Barfi comprising low calorie, low glycemic index, and sustained energy release sugar composition comprising isomaltulose in an amount of from about 0% to about 20%, trehalulose in an amount of from about 0% to about 20% and D-allulose in an amount of from about 0% to about 20% by weight relative to the total weight of the uncooked product; wherein isomaltulose, trehalulose and D-allulose are not 0% simultaneously. In certain embodiments, the isomaltulose may present in an amount of from about 1% to about 10%, trehalulose may present in an amount of from about 1% to about 10% and D-allulose may present in an amount of from about 0% to about 10% by weight relative to the total weight of the uncooked product. In certain, embodiments, the Kesar Pista Barfi may further comprise at least one soluble oligosaccharide in an amount from about 0.1% to about 1% by weight relative to the total weight of the sweet and, optionally, one or more soluble essential trace element and nutritive sweetener. The Kesar Pista Barfi according to the present invention may include one or more ingredients suitable for inclusion in Kesar Pista Barfi.

By way of example, Kesar Pista Barfi according to the present invention may comprise the following ingredients:

Kesar Pista Barfi

| | Amount, in % |
|---|---|
| Ingredients | (w/w) |
| Full Cream Milk | 60-90 |
| Corn Flour | 1.0-3 |
| Pistachio powder | 5.0-15 |
| Sucrose | 0-20 |
| Isomaltulose | 0-20 |
| Trehalulose | 0-20 |
| Allulose | 0-20 |
| Isomaltooligosaccharide | 0-1 |
| Cardimom powder | 0.1-0.5 |
| Saffron crushed (strands) | 0.01-0.05 |
| Total | 100 |

In certain embodiments, the present invention provides Malai Peda comprising low calorie, low glycemic index, and sustained energy release sugar composition comprising isomaltulose in an amount of from about 0% to about 40%, trehalulose in an amount of from about 0% to about 40% and D-allulosein an amount of from about 0% to about 40% by weight relative to the total weight of the uncooked product; wherein isomaltulose, trehalulose and D-allulose are not 0% simultaneously. In certain embodiments, the isomaltulose may present in an amount of from about 2% to about 20%, trehalulose may present in an amount of from about 2% to about 20% and D-allulose may present in an amount of from about 0% to about 15% by weight relative to the total weight of the uncooked product. In certain, embodiments, the Malai Peda may further comprise at least one soluble oligosaccharide in an amount from about 0.1% to about 1% by weight relative to the total weight of the Indian sweet and, optionally, one or more soluble essential trace element and nutritive sweetener. The Malai Peda according to the present invention may include one or more ingredients suitable for inclusion in Malai Peda.

By way of example, Malai Peda according to the present invention may comprise the following ingredients:

Malai Peda

| Ingredients | Amount, in % (w/w) |
|---|---|
| Full Cream Milk | 30-70 |
| Condensed Milk | 10.0-30 |
| Corn Flour | 0.5-10 |
| Lemon extract | 0.2-1 |
| Sucrose | 0-40 |
| Isomaltulose | 0-40 |
| Trehalulose | 0-40 |
| Allulose | 0-40 |
| Isomaltooligosaccharide | 0-1 |
| Ghee/Butter | 0.5-2 |
| Cardamom Powder | 0.1-0.5 |
| Saffron Color (drops) | 0.1-0.5 |
| Water | 5.0-10 |
| Total | 100 |

In certain embodiments, the present invention provides Doodh Peda comprising low calorie, low glycemic index, and sustained energy release sugar composition comprising isomaltulose in an amount of from about 0% to about 40%, trehalulose in an amount of from about 0% to about 40% and D-allulose in an amount of from about 0% to about 40% by weight relative to the total weight of the uncooked product; wherein isomaltulose, trehalulose and D-allulose are not 0% simultaneously. In certain embodiments, the isomaltulose may present in an amount of from about 3% to about 15%, trehalulose may present in an amount of from about 2% to about 15% and D-allulose may present in an amount of from about 2% to about 10% by weight relative to the total weight of the uncooked product. In certain, embodiments, the Doodh Peda may further comprise at least one soluble oligosaccharide in an amount from about 0.1% to about 1% by weight relative to the total weight of the Indian sweet and, optionally, one or more soluble essential trace element and nutritive sweetener. The Doodh Peda according to the present invention may include one or more ingredients suitable for inclusion in Doodh Peda.

By way of example, Doodh Peda according to the present invention may comprise the following ingredients:

Doodh Peda

| Ingredients | Amount, in % (w/w) |
|---|---|
| Milk Powder | 40-60 |
| Unsalted Butter | 1.0-5.0 |
| Full Cream Milk | 10.0-40.0 |
| Sucrose | 0-40 |
| Isomaltulose | 0-40 |
| Trehalulose | 0-40 |
| Allulose | 0-40 |
| Isomaltooligosaccharide | 0.0-1.0 |
| Cardimom Powder | 0.01-0.5 |
| Water | 5.0-15.0 |
| Total | 100 |

In certain embodiments, the present invention provides Kaju Barfi comprising low calorie, low glycemic index, and sustained energy release sugar composition comprising isomaltulose in an amount of from about 0% to about 50%, trehalulose in an amount of from about 0% to about 50% and D-allulose in an amount of from about 0% to about 50% by weight relative to the total weight of the uncooked product; wherein isomaltulose, trehalulose and D-allulose are not 0% simultaneously. In certain embodiments, the isomaltulose may present in an amount of from about 5% to about 30%, trehalulose may present in an amount of from about 5% to about 30% and D-allulose may present in an amount of from about 0% to about 15% by weight relative to the total weight of the uncooked product. In certain, embodiments, the Kaju Barfi may further comprise at least one soluble oligosaccharide in an amount from about 0.1% to about 1% by weight relative to the total weight of the uncooked product and, optionally, one or more soluble essential trace element and nutritive sweetener. The Kaju Barfi according to the present invention may include one or more ingredients suitable for inclusion in Kaju Barfi.

By way of example Kaju Barfi according to the present invention may comprise the following ingredients:

Kaju Barfi

| Ingredients | Amount, % (w/w) |
|---|---|
| Dried Cashew nuts powder | 10.0-30.0 |
| Khoya | 30.0-60.0 |
| Sucrose | 0-50 |
| Isomaltulose | 0-50 |
| Trehalulose | 0-50 |
| Allulose | 0-50 |
| Isomaltooligosaccharide | 0.0-1.0 |
| Cardamom Powder | 0.01-0.5 |
| Water | 5.0-15.0 |
| Silver foil | 0.1-0.5 |
| Total | 100 |

In certain embodiments, the present invention provides Ras Malai comprising low calorie, low glycemic index, and sustained energy release sugar composition comprising isomaltulose in an amount of from about 0% to about 40%, trehalulose in an amount of from about 0% to about 40% and D-allulose in an amount of from about 0% to about 40% by weight relative to the total weight of the uncooked product; wherein isomaltulose, trehalulose and D-allulose are not 0% simultaneously. In certain embodiments, the isomaltulose may present in an amount of from about 2% to about 20%, trehalulose may present in an amount of from about 2% to about 20% and D-allulose may present in an amount of from about 0% to about 10% by weight relative to the total weight of the uncooked product; wherein isomaltulose, trehalulose and D-allulose are not 0% simultaneously. In certain, embodiments, the Ras Malai may further comprise at least one soluble oligosaccharide in an amount from about 0.1% to about 1% by weight relative to the total weight of the uncooked product and, optionally, one or more soluble essential trace element and nutritive sweetener. The Ras Malai according to the present invention may include one or more ingredients suitable for inclusion in Ras Malai.

By way of example, Ras Malai according to the present invention may comprise the following ingredients:

Ras Malai

| Ingredients | % (w/w) |
|---|---|
| Chena/Paneer | 10.0-40 |
| Rabadi | 30-60 |
| Sucrose | 0-40 |
| Isomaltulose | 0-40 |
| Trehalulose | 0-40 |
| Allulose | 0-40 |
| Isomaltooligosaccharide | 0.0-1.0 |
| Cardamom Powder | 0.01-0.05 |
| Saffron color (drops) | 0.1-0.5 |
| Total | 100 |

In certain embodiments, the present invention provides Soan Papdi comprising low calorie, low glycemic index, and sustained energy release sugar composition comprising isomaltulose in an amount of from about 0% to about 40%, trehalulose in an amount of from about 0% to about 40% and D-allulose in an amount from about 0% to about 40% by weight relative to the total weight of the uncooked product; wherein isomaltulose, trehalulose and D-allulose are not 0% simultaneously. In certain embodiments, the isomaltulose may present in an amount of from about 3% to about 20%, trehalulose may present in an amount of from about 3% to about 20% and D-allulose may present in an amount of from about 0% to about 10% by weight relative to the total weight of the uncooked product. In certain, embodiments, the Soan Papdi may further comprise at least one soluble oligosaccharide in an amount from about 0.1% to about 1% by weight relative to the total weight of the uncooked product and, optionally, one or more soluble essential trace element and nutritive sweetener. The Soan Papdi according to the present invention may include one or more ingredients suitable for inclusion in Soan Papdi.

By way of example, Soan Papdi according to the present invention may comprise the following ingredients:

Patisa (Soan Papdi)

| | Amount, in % |
|---|---|
| Ingredients | (w/w) |
| Gram Flour | 10.0-30 |
| Refined Flour/Maida | 10.0-30 |
| Ghee/Butter | 5.0-15 |
| Full Cream Milk | 1.0-10 |
| Sucrose | 0-40 |
| Isomaltulose | 0-40 |
| Trehalulose | 0-40 |
| Allulose | 0-40 |
| Isomaltooligosaccharide | 0.0-1.0 |
| Chopped almond, Cheshue, | 0.5-2.0 |
| Pista | |
| Cardamom seed | 0.01-0.05 |
| Water | 10.0-30.0 |
| Total | 100 |

In certain embodiments, the present invention provides use of a low calorie, low glycemic index (GI), and sustained energy release sugar composition comprising a combination of isomaltulose, trehalulose and D-allulose; at least one of the following: essential trace elements, soluble oligosaccharides and bulking agents; and optionally, one or more nutritive sweetener in food and beverage products.

In yet another, embodiment, the present invention provides a low calorie, low glycemic index (GI), and sustained energy release sugar composition comprising a combination of isomaltulose, trehalulose and D-allulose; at least one of the following: essential trace elements, soluble oligosaccharides and bulking agents; and optionally, one or more nutritive sweetener for use in a food and beverage product.

The bakery products of the present invention may also contain one or more additional ingredients selected from a wide variety of food-grade materials. According to the desired properties of the bakery product, any number of ingredients may be selected, alone or in combination, based upon their known uses in preparation of solid foodstuff. Such ingredients include, but are not limited to, viscosity enhancing, or thickening agents improving the texture of the product, aroma components, flavour components, texture enhancers, colour substances, taste masking substances and antioxidants.

### EXAMPLES

The invention will now be illustrated by means of the following examples, it being understood that these are intended to explain the invention, and in no way to limit its scope. Unless described otherwise, all the food and beverage products were prepared using methods known in the art and affective testing of all the prepared food and beverage products were conducted using a 9-point hedonic scale.

### Example 1: Table-Top Sugar

The composition of the Table top Sugar is shown in Table 1.

TABLE 1

| | Control | | | | | | | | | | Ex | Ex | Ex |
|---|---|---|---|---|---|---|---|---|---|---|---|---|---|
| | % | Ex 1 % | Ex 2 % | Ex 3 % | Ex 4 % | Ex 5 % | Ex 6 % | Ex 7 % | Ex 8 % | Ex 9 % | 10 % | 11 % | 12 % |
| Ingredients | (w/w) | (w/w) | (w/w) | (w/w) | (w/w) | (w/w) | (w/w) | (w/w) | (w/w) | (w/w) | (w/w) | (w/w) | (w/w) |
| Sucrose | 100 | 0 | 0 | 0 | 0 | 0 | 0 | 0 | 0 | 0 | 0 | 0 | 0 |
| Allulose | 0 | 84.35 | 64.4 | 38.85 | 84.88 | 64.35 | 38.9 | 39.38 | 14.35 | 13.85 | 49.38 | 49.35 | 23.85 |
| Isomaltulose | 0 | 5 | 25 | 50 | 0 | 0 | 0 | 25 | 50 | 70 | 25 | 25 | 50 |
| Trehalulose | 0 | 0 | 0 | 0 | 5 | 25 | 50 | 25 | 25 | 5 | 25 | 25 | 25 |
| Invert Sugar | 0 | 10 | 10 | 10 | 10 | 10 | 10 | 10 | 10 | 10 | 0 | 0 | 0 |
| Isomaltooligosaccharide | 0 | 0.5 | 0.5 | 1 | 0 | 0.5 | 1 | 0.5 | 0.5 | 1 | 0.5 | 0.5 | 1 |
| Citic acid | 0 | 0.1 | 0.1 | 0.1 | 0.1 | 0.1 | 0.1 | 0.1 | 0.1 | 0.1 | 0.1 | 0.1 | 0.1 |
| Essential trace | 0 | 0.05 | 0.0.5 | 0.05 | 0.02 | 0.05 | 0.0.5 | 0.02 | 0.05 | 0.05 | 0.02 | 0.05 | 0.05 |
| element (Ca, Zn, | | | | | | | | | | | | | |
| Fe) | | | | | | | | | | | | | |
| Total | 100 | 100 | 100 | 100 | 100 | 100 | 100 | 100 | 100 | 100 | 100 | 100 | 100 |
| Calories | 400 | 78 | 154 | 250 | 77 | 154 | 250 | 249 | 344 | 345 | 211 | 211 | 307 |
| GI | 65.0 | 7.8 | 14.2 | 22.4 | 7.6 | 14.2 | 22.4 | 22.2 | 30.2 | 30.4 | 16.2 | 16.2 | 24.4 |
| GL | 65.0 | 7.7 | 14.1 | 22.1 | 7.6 | 14.1 | 22.1 | 22.1 | 30.0 | 30.0 | 16.1 | 16.1 | 24.1 |
| Sweetness | 100.0 | 73.8 | 69.8 | 64.7 | 74.4 | 72.3 | 69.7 | 67.3 | 62.3 | 60.2 | 62.3 | 62.3 | 57.2 |

### Example 2: Flavored Water

The composition of the flavored water is shown in Table 2.

| | Control | Ex 1 | Ex 2 | Ex 3 | Ex 4 | Ex 5 | Ex 6 |
|---|---|---|---|---|---|---|---|
| Ingredients | (%) | (%) | (%) | (%) | (%) | (%) | (%) |
| Allulose | 0 | 5 | 5 | 5 | 5 | 5 | 5 |
| Isomaltulose | 0 | 10 | 0 | 5 | 5 | 5 | 5 |
| Trehalulose | 0 | 0 | 10 | 5 | 5 | 5 | 5 |
| Invert Sugar | 5 | 0 | 0 | 0 | 1 | 1 | 0 |
| (optional) | | | | | | | |
| Soluble | 0 | 0.3 | 0.3 | 0.3 | 0.3 | 0.5 | 0.5 |
| Oligosaccharide | | | | | | | |
| Potassium | 0.03 | 0.03 | 0.03 | 0.03 | 0.03 | 0.03 | 0.03 |
| Citrate | | | | | | | |
| Citric acid, fine | 0.1 | 0.1 | 0.1 | 0.1 | 0.1 | 0.1 | 0.1 |
| Flavor | 0.1 | 0.1 | 0.1 | 0.1 | 0.1 | 0.1 | 0.1 |
| water | 94.77 | 84.47 | 84.47 | 84.47 | 83.47 | 83.27 | 84.27 |
| Total | 100 | 100 | 100 | 100 | 100 | 100 | 100 |
| Calories | 20 | 41.72 | 41.72 | 41.72 | 45.72 | 46.2 | 42.2 |
| GI | 60.0 | 21.60 | 23.56 | 22.58 | 24.88 | 25.00 | 22.74 |
| GL | 3.0 | 3.24 | 3.53 | 3.39 | 3.98 | 4.00 | 3.41 |
| Sweetness | 6.0 | 8.65 | 9.65 | 9.15 | 10.35 | 10.45 | 9.25 |

### Example 3: Flavored Yogurt

The composition of the flavored yogurt is shown in Table 3.

TABLE 3

| | Control | Ex 1 | Ex 2 | Ex 3 | Ex 4 |
|---|---|---|---|---|---|
| Ingredients | (%) | (%) | (%) | (%) | (%) |
| Whole Milk | 20 | 20 | 20 | 20 | 20 |
| Lactobacillus sp | 1 | 1 | 1 | 1 | 1 |
| Allulose | 0 | 30 | 30 | 30 | 30 |
| Isomaltulose | 0 | 10 | 20 | 0 | 10 |
| Trehalulose | 0 | 10 | 0 | 20 | 10 |
| Invert Sugar | 30 | 0 | 0 | 0 | 10 |
| Isomaltooligosaccharide | 0 | 0.5 | 0.5 | 0.5 | 0.5 |
| Flavor | 0.5 | 0.5 | 0.5 | 0.5 | 0.5 |
| Food color (optional) | 0.05 | 0.05 | 0.05 | 0.05 | 0.05 |
| Water | 48.45 | 27.95 | 27.95 | 27.95 | 17.95 |
| Total | 100 | 100 | 100 | 100 | 100 |
| Calories | 120 | 87 | 87 | 87 | 127 |
| GI | 60 | 14 | 13 | 14 | 21 |
| GL | 18 | 7 | 7 | 7 | 13 |
| Sweetness | 36 | 32 | 31 | 33 | 44 |

### Example 4: Sweet Bakery Cookies

The composition of the sweet bakery cookies is shown in Table 4.

TABLE 4

| | Control | Ex 1 | Ex 2 | Ex 3 | Ex 4 |
|---|---|---|---|---|---|
| Ingredients | (%) | (%) | (%) | (%) | (%) |
| Invert Sugar | 0 | 5 | 5 | 0 | 5 |
| Granulated Sugar | 30 | 5 | 0 | 0 | 0 |
| Allulose | 0 | 20 | 30 | 30 | 35 |
| isomaltulose | 0 | 5 | 0 | 5 | 0 |
| trehalulose | 0 | 5 | 5 | 0 | 0 |
| Isomaltooligosaccharide | 0 | 0.3 | 0.3 | 0.3 | 0.3 |
| Butter, unsalted | 15 | 15 | 15 | 15 | 15 |
| Essential trace element | 0.05 | 0.05 | 0.05 | 0.05 | 0.05 |
| (Zn, Ca, Fe) | | | | | |
| Eggs, whole, dried | 7 | 7 | 7 | 7 | 7 |
| Flavor extract | 0.2 | 0.2 | 0.2 | 0.2 | 0.2 |
| All purpose white flour | 30 | 30 | 30 | 30 | 30 |
| Baking Soda | 0.5 | 0.5 | 0.5 | 0.5 | 0.5 |
| Semi sweet chocolate | 5 | 5 | 5 | 5 | 5 |
| chips | | | | | |
| Water | 12.25 | 1.95 | 1.95 | 6.95 | 1.95 |
| Total | 100 | 100 | 100 | 100 | 100 |
| Calories | 120 | 85 | 47 | 27 | 28 |
| GI | 65 | 24 | 12 | 5 | 8 |
| GL | 20 | 10 | 5 | 2 | 3 |
| Sweetness | 30 | 31 | 30 | 24 | 31 |

### Example 5: Sweet General Cake

The composition of the sweet general cake is shown in Table 5.

TABLE 5

| | Control | Ex 1 | Ex 2 | Ex 3 | Ex 4 |
|---|---|---|---|---|---|
| Ingredients | (%) | (%) | (%) | (%) | (%) |
| Allulose | 0 | 20 | 20 | 15 | 10 |
| Granulated sugar white | 40 | 0 | 0 | 5 | 10 |
| Isomaltulose | 0 | 20 | 0 | 10 | 10 |
| Trehalulose | 0 | 0 | 20 | 10 | 10 |
| Isomaltooligosaccharide | 0 | 0.3 | 0.3 | 0.3 | 0.3 |
| Cake flour (varities) | 25 | 25 | 25 | 25 | 25 |
| Baking Powder | 1 | 1 | 1 | 1 | 1 |
| Salt, iodized | 0.45 | 0.45 | 0.45 | 0.45 | 0.45 |
| Essential trace element | 0.05 | 0.05 | 0.05 | 0.05 | 0.05 |
| (Zn, Fe) | | | | | |
| Milk, whole | 10 | 10 | 10 | 10 | 10 |
| Egg, whole | 11 | 11 | 11 | 11 | 11 |
| Butter. Unsalted | 12.3 | 12 | 12 | 12 | 12 |
| Flavor extract | 0.2 | 0.2 | 0.2 | 0.2 | 0.2 |
| Total | 100 | 100 | 100 | 100 | 100 |
| Calories | 160 | 85 | 85 | 104 | 123 |
| GI | 65 | 16 | 18 | 25 | 33 |
| GL | 26 | 6 | 7 | 10 | 13 |
| Sweetness | 40 | 24 | 26 | 27 | 28 |

### Example 6: Sweet Breads Buns/Rolls

The composition is shown in Table 6.

TABLE 6

| | Control | Ex 1 | Ex 2 | Ex 3 | Ex 4 |
|---|---|---|---|---|---|
| Ingredient | (%) | (%) | (%) | (%) | (%) |
| Allulose | 0 | 20 | 20 | 10 | 10 |
| Isomaltulose | 0 | 10 | 0 | 10 | 5 |
| Trehalulose | 0 | 0 | 10 | 10 | 5 |
| Invert sugar | 30 | 0 | 0 | 0 | 10 |
| Isomaltooligosaccharide | 0 | 0.3 | 0.3 | 0.3 | 0.3 |
| Bread flour | 45 | 45 | 45 | 45 | 45 |
| Table salt | 0.95 | 0.95 | 0.95 | 0.95 | 0.95 |
| Essential trace element | 0.05 | 0.05 | 0.05 | 0.05 | 0.05 |
| (Zn, Fe) | | | | | |
| Powder Milk | 2 | 2 | 2 | 2 | 2 |
| Vegetable oil | 1.5 | 1.5 | 1.5 | 1.5 | 1.5 |
| Di-acyl glycerol | 0.5 | 0.5 | 0.5 | 0.5 | 0.5 |
| Potasium bisulphite | 0.02 | 0.02 | 0.02 | 0.02 | 0.02 |
| Water | 19.98 | 19.68 | 19.68 | 19.68 | 19.68 |
| Total | 100 | 100 | 100 | 100 | 100 |
| Calories | 120 | 45 | 45 | 83 | 83 |
| GI | 60 | 11 | 12 | 22 | 31 |
| GL | 18 | 3 | 4 | 7 | 9 |
| Sweetness | 36 | 19 | 20 | 18 | 25 |

### Example 7: Ice-Cream

The composition is shown in Table 7.

TABLE 7

| | Control | Ex 1 | Ex 2 | Ex 3 | Ex 4 |
|---|---|---|---|---|---|
| Ingradient | % | (%) | (%) | (%) | (%) |
| Cream (36% butter fat) | 26.2 | 26.2 | 26.2 | 26.2 | 26.2 |
| (5.4% Solid) | | | | | |
| Milk (3.5% fat) | 43.8 | 43.8 | 43.8 | 43.8 | 43.8 |
| (9% solid)Milk | | | | | |
| Non-fat dry milk | 5 | 5 | 5 | 5 | 5 |
| powder | | | | | |
| (97% Solid) | | | | | |
| Invert Sugar | 24 | 4 | 4 | 0 | 5 |
| Allulose | 0 | 10 | 10 | 8 | 15 |
| Isomaltulose | 0 | 10 | 0 | 8 | 2 |
| Trehalulose | 0 | 0 | 10 | 8 | 2 |
| Isomaltooligosaccharide | 0 | 0.5 | 0.5 | 0.5 | 0.5 |
| Stabilizer | 0.5 | 0.25 | 0.25 | 0.25 | 0.25 |
| Emulsifier | 0.5 | 0.25 | 0.25 | 0.25 | 0.25 |
| Total | 100 | 100 | 100 | 100 | 100 |
| Calories | 96 | 59 | 59 | 67 | 40 |
| GI | 60 | 24 | 25 | 23 | 18 |
| GL | 14 | 6 | 6 | 5 | 4 |
| Sweetness | 29 | 17 | 18 | 15 | 19 |

### Example 8: Snack Bar

The composition is shown in Table 8.

TABLE 8

| | Control | Ex 1 | Ex 2 | Ex 3 | Ex 4 |
|---|---|---|---|---|---|
| Ingredient | (%) | (%) | (%) | (%) | (%) |
| Oat flour | 40 | 40 | 40 | 40 | 40 |
| Rice Flour | 11.6 | 11.6 | 11.6 | 11.6 | 11.6 |
| Raisin, pista. Almond, | 7.5 | 7.5 | 7.5 | 7.5 | 7.5 |
| apricot | | | | | |
| Invert sugar | 30 | 0 | 0 | 5 | 0 |
| Table Sugar | 0 | 0 | 0 | 5 | 0 |
| Allulose | 0 | 20 | 20 | 10 | 10 |
| Isomaltulose | 0 | 10 | 0 | 5 | 10 |
| Trehalulose | 0 | 0 | 10 | 5 | 10 |
| Isomaltooligosaccharide | 0 | 0.3 | 0.3 | 0.3 | 0.3 |
| Sunflower oil | 3 | 3 | 3 | 3 | 3 |
| Glycerin | 4 | 4 | 4 | 4 | 4 |
| Flavor | 0.2 | 0.2 | 0.2 | 0.2 | 0.2 |
| Table salt | 0.3 | 0.3 | 0.3 | 0.3 | 0.3 |
| Essential trace element | 0.05 | 0.05 | 0.05 | 0.05 | 0.05 |
| Water | 3.35 | 3.05 | 3.05 | 3.05 | 3.05 |
| Total | 100 | 100 | 100 | 100 | 100 |
| Calories | 120 | 45 | 45 | 83 | 83 |
| GI | 60 | 11 | 12 | 32 | 22 |
| GL | 18 | 3 | 4 | 10 | 7 |
| Sweetness | 36 | 19 | 20 | 24 | 18 |

### Example 9: Carbonated Beverage

The composition is shown in Table 9.

TABLE 9

| | Control | Ex 1 | Ex 2 | Ex 3 | Ex 4 |
|---|---|---|---|---|---|
| Ingredient | (%) | (%) | (%) | (%) | (%) |
| Invert sugar | 70 | 10 | 10 | 0 | 10 |
| Allulose | 0 | 50 | 50 | 30 | 10 |
| Isomaltulose | 0 | 10 | 0 | 20 | 25 |
| Trehalulose | 0 | 0 | 10 | 20 | 25 |
| Isomaltooligosaccharide | 0 | 0.3 | 0.3 | 0.3 | 0.3 |
| Citric Acid | 0.6 | 0.6 | 0.6 | 0.6 | 0.6 |
| Flavor | 0.2 | 0.2 | 0.2 | 0.2 | 0.2 |
| Sodium Citrate | 0.1 | 0.1 | 0.1 | 0.1 | 0.1 |
| Sodium Benzoate | 0.1 | 0.1 | 0.1 | 0.1 | 0.1 |
| Water | 29 | 28.7 | 28.7 | 28.7 | 28.7 |
| Total | 100 | 100 | 100 | 100 | 100 |
| Calories | 280 | 91 | 91 | 167 | 243 |
| GI | 60 | 13 | 14 | 19 | 33 |
| GL | 42 | 9 | 10 | 13 | 23 |
| Sweetness | 84 | 52 | 53 | 43 | 47 |

### Example 10: Gelatin Gummy Candy

The composition is shown in Table 10.

TABLE 10

| | Control | Ex 1 | Ex 2 | Ex 3 | Ex 4 | Ex 5 |
|---|---|---|---|---|---|---|
| Ingredient | (%) | (%) | (%) | (%) | (%) | (%) |
| Invert sugar | 50 | 0 | 0 | 15 | 25 | 0 |
| Sucrose | 28 | 25 | 0 | 15 | 0 | 0 |
| Allulose | 0 | 30 | 45 | 15 | 0 | 25 |
| Isomaltulose | 0 | 20 | 15 | 15 | 25 | 25 |
| Trehalulose | 0 | 0 | 15 | 15 | 25 | 25 |
| Isomaltooligosaccharide | 0 | 0.3 | 0.3 | 0.3 | 0.3 | 0.3 |
| Pectin | 0 | 2 | 2 | 2 | 2 | 2 |
| Citric acid 50% | 1.5 | 1.5 | 1.5 | 1.5 | 1.5 | 1.5 |
| Flavour | 0.2 | 0.2 | 0.2 | 0.2 | 0.2 | 0.2 |
| Coating agent | 0.1 | 0.1 | 0.1 | 0.1 | 0.1 | 0.1 |
| water | 20.2 | 20.9 | 20.9 | 20.9 | 20.9 | 20.9 |
| Total | 100 | 100 | 100 | 100 | 100 | 100 |
| Calories | 312 | 187 | 130 | 244 | 301 | 206 |
| GI | 62 | 30 | 13 | 38 | 42 | 22 |
| GL | 48 | 23 | 10 | 29 | 32 | 17 |
| Sweetness | 88 | 56 | 48 | 60 | 58 | 45 |

### Example 11: Agra Petha

The composition is shown in Table 11.

TABLE 11

| | Control | Ex 1 | Ex 2 | Ex 3 |
|---|---|---|---|---|
| Ingredients | (%) | (%) | (%) | (%) |
| Sliced white pumpkin | 43.0 | 43.0 | 43.0 | 43.0 |
| Sucrose | 34.8 | 0.0 | 8.6 | 21.5 |
| Isomaltulose | 0.0 | 17.2 | 8.6 | 4.3 |
| Trehalulose | 0.0 | 17.2 | 8.6 | 4.3 |
| Allulose | 0.0 | 0.0 | 8.6 | 4.3 |
| Isomaltooligosaccharide | 0.0 | 0.5 | 0.5 | 0.5 |
| Lime | 0.4 | 0.4 | 0.4 | 0.4 |
| rose water (ml) | 0.2 | 0.2 | 0.2 | 0.2 |
| water (ml) | 21.4 | 21.4 | 21.4 | 21.4 |
| Total | 100 | 100 | 100 | 100 |
| Calories | 139 | 139 | 106 | 122 |
| GI | 65 | 16 | 24 | 44 |
| GL | 23 | 6 | 8 | 15 |
| Sweetness | 35 | 19 | 24 | 29 |

### Example 12: Balushahi

The composition is shown in Table 12.

TABLE 12

| | Control | Ex 1 | Ex 2 | Ex 3 |
|---|---|---|---|---|
| Ingredients | (%) | (%) | (%) | (%) |
| Wheat Flour | 33.3 | 33.3 | 33.3 | 33.3 |
| Sucrose | 10.7 | 3.3 | 0.0 | 0.0 |
| Isomaltulose | 0.0 | 3.3 | 5.0 | 3.3 |
| Trehalulose | 0.0 | 3.3 | 3.3 | 3.3 |
| Allulose | 0.0 | 0.0 | 1.7 | 3.3 |
| Isomaltooligosaccharide | 0.0 | 0.5 | 0.5 | 0.5 |
| Butter | 5.0 | 5.0 | 5.0 | 5.0 |
| Essential trace element (Zn, Fe, Ca) | 0.0 | 0.2 | 0.2 | 0.2 |
| Table Salt | 1.0 | 1.0 | 1.0 | 1.0 |
| Oil (Food grade) | 33.3 | 33.3 | 33.3 | 33.3 |
| water | 16.7 | 16.7 | 16.7 | 16.7 |
| Total | 100 | 100 | 100 | 100 |
| Calories | 43 | 41 | 35 | 29 |
| GI | 65 | 44 | 28 | 23 |
| GL | 7 | 4 | 3 | 2 |
| Sweetness | 11 | 7 | 6 | 6 |

### Example 13: Besan Laddu

The composition is shown in Table 13.

TABLE 13

| | Control | Ex 1 | Ex 2 | Ex 3 |
|---|---|---|---|---|
| Ingredients | (%) | (%) | (%) | (%) |
| Besan (Gram Flour) | 60 | 60 | 60 | 60 |
| Sucrose | 20.4 | 0 | 5 | 0 |
| Isomaltulose | 0 | 10 | 7.5 | 7.5 |
| Trehalulose | 0 | 10 | 7.5 | 7.5 |
| Allulose | 0 | 0 | 0 | 5 |
| Isomaltooligosaccharide | 0 | 0.4 | 0.4 | 0.4 |
| Butter/Ghee | 2 | 2 | 2 | 2 |
| Cardamom powder | 0.1 | 0.1 | 0.1 | 0.1 |
| water | 17.5 | 17.5 | 17.5 | 17.5 |
| Total | 100 | 100 | 100 | 100 |
| Calories | 82 | 81 | 81 | 62 |
| GI | 65 | 34 | 41 | 25 |
| GL | 13 | 7 | 8 | 5 |
| Sweetness | 20 | 11 | 13 | 12 |

### Example 14: Gajar Ka Halwa

The composition is shown in Table 14.

TABLE 14

| | Control | Ex 1 | Ex 2 | Ex 3 |
|---|---|---|---|---|
| Ingredients | (%) | (%) | (%) | (%) |
| Carrot Red | 40 | 40 | 40 | 40 |
| Pure Ghee/Butter | 0.8 | 0.8 | 0.8 | 0.8 |
| Milk (full cream) | 41.68 | 41.6 | 41.6 | 41.6 |
| Sucrose | 12.4 | 0 | 2 | 0 |
| Isomaltulose | 0 | 6 | 8 | 4 |
| Trehalulose | 0 | 6 | 2 | 4 |
| Allulose | 0 | 0 | 0 | 4 |
| Isomaltooligosaccharide | 0 | 0.5 | 0.5 | 0.5 |
| Crashed Dry fruits | 5 | 5 | 5 | 5 |
| Cardimom powder | 0.12 | 0.1 | 0.1 | 0.1 |
| Total | 100 | 100 | 100 | 100 |
| Calories | 50 | 49 | 49 | 34 |
| GI | 65 | 34 | 38 | 23 |
| GL | 8 | 4 | 5 | 3 |
| Sweetness | 12 | 7 | 7 | 7 |

### Example 15: Rasgulla

The composition is shown in Table 15.

TABLE 15

| | Control | Ex 1 | Ex 2 | Ex 3 |
|---|---|---|---|---|
| Ingredients | (%) | (%) | (%) | (%) |
| Cottage Cheese | 76.3 | 76.3 | 76.3 | 76.3 |
| Sucrose | 23.2 | 0.0 | 0.0 | 3.8 |
| Isomaltulose | 0.0 | 11.5 | 7.6 | 7.6 |
| Trehalulose | 0.0 | 11.5 | 7.6 | 7.6 |
| Allulose | 0.0 | 0.0 | 7.6 | 3.8 |
| Solible Fiber | 0.0 | 0.3 | 0.3 | 0.3 |
| Lemon extract | 0.4 | 0.4 | 0.4 | 0.4 |
| Rose Essence (optional) | 0.1 | 0.1 | 0.1 | 0.1 |
| Total | 100 | 100 | 100 | 100 |
| Calories | 93 | 92 | 63 | 78 |
| GI | 65 | 34 | 23 | 33 |
| GL | 15 | 8 | 5 | 8 |
| Sweetness | 23 | 13 | 14 | 15 |

### Example 16: Gulab Jamun

The composition is shown in Table 16.

TABLE 16

| | Control | Ex 1 | Ex 2 | Ex 3 |
|---|---|---|---|---|
| Ingredients | (%) | (%) | (%) | (%) |
| Nonfat Dry Milk | 35.7 | 35.7 | 35.7 | 35.7 |
| Milk | 3.6 | 3.6 | 3.6 | 3.6 |
| All purpose flour | 14.3 | 14.3 | 14.3 | 14.3 |
| Melted Ghee/butter | 2.9 | 2.9 | 2.9 | 2.9 |
| Baking Soda | 0.1 | 0.1 | 0.1 | 0.1 |
| Sucrose (Light brown) | 43.4 | 0.0 | 0.0 | 7.1 |
| Isomaltulose | 0.0 | 21.4 | 14.3 | 17.9 |
| Trehalulose | 0.0 | 21.4 | 14.3 | 17.9 |
| Allulose | 0.0 | 0.0 | 14.3 | 0.0 |
| Isomaltooligosaccharide | 0.0 | 0.6 | 0.6 | 0.6 |
| Cardimom pods | 0.1 | 0.1 | 0.1 | 0.1 |
| Total | 100 | 100 | 100 | 100 |
| Calories | 174 | 173 | 119 | 173 |
| GI | 65 | 34 | 23 | 39 |
| GL | 28 | 14 | 10 | 17 |
| Sweetness | 43 | 24 | 26 | 27 |

### Example 17: Jalebi (North Indian)

The composition is shown in Table 17.

TABLE 17

| | Control | Ex 1 | Ex 2 | Ex 3 |
|---|---|---|---|---|
| Ingredients | (%) | (%) | (%) | (%) |
| Refine Flour/Maida | 33.1 | 33.1 | 33.1 | 33.1 |
| Gram Flour/Besan | 5.5 | 5.5 | 5.5 | 5.5 |
| Yogurt | 5.5 | 5.5 | 5.5 | 5.5 |
| Sucrose | 55.8 | 0.0 | 11.0 | 0.0 |
| Isomaltulose | 0.0 | 27.6 | 22.1 | 22.1 |
| Trehalulose | 0.0 | 27.6 | 22.1 | 22.1 |
| Allulose | 0.0 | 0.0 | 0.0 | 11.0 |
| Isomaltooligosaccharide | 0.0 | 0.6 | 0.6 | 0.6 |
| Total | 100 | 100 | 100 | 100 |
| Calories | 223 | 222 | 222 | 180 |
| GI | 65 | 34 | 40 | 27 |
| GL | 36 | 19 | 22 | 15 |
| Sweetness | 56 | 31 | 36 | 32 |

### Example 18: Kalakand

The composition of the is shown in Table 18.

TABLE 18

| | Control | Ex 1 | Ex 2 | Ex 3 |
|---|---|---|---|---|
| Ingredients | (%) | (%) | (%) | (%) |
| Cow Milk for chena | 39.8 | 39.8 | 39.8 | 39.8 |
| Cow Milk | 39.8 | 39.8 | 39.8 | 39.8 |
| Chopped Nut | 4.0 | 4.0 | 4.0 | 4.0 |
| Citric Acid | 0.1 | 0.1 | 0.1 | 0.1 |
| Sucrose | 12.3 | 0.0 | 0.0 | 2.0 |
| Isomaltulose | 0.0 | 6.0 | 4.0 | 4.0 |
| Trehalulose | 0.0 | 6.0 | 4.0 | 4.0 |
| Allulose | 0.0 | 0.0 | 4.0 | 2.0 |
| Isomaltooligosaccharide | 0.0 | 0.4 | 0.4 | 0.4 |
| Silver foil (optional) | 0.02 | 0.02 | 0.02 | 0.02 |
| Water | 4.0 | 4.0 | 4.0 | 4.0 |
| Total | 100 | 100 | 100 | 100 |
| Calories | 49 | 49 | 34 | 41 |
| GI | 65 | 34 | 23 | 33 |
| GL | 8 | 4 | 3 | 4 |
| Sweetness | 12 | 7 | 7 | 8 |

### Example 19: Kesar Pista Barfi

The composition of the is shown in Table 19.

TABLE 19

| | Control | Ex 1 | Ex 2 | Ex 3 |
|---|---|---|---|---|
| Ingredients | (%) | (%) | (%) | (%) |
| Full Cream Milk | 81.4 | 81.4 | 81.4 | 81.4 |
| Corn Flour | 1.6 | 1.6 | 1.6 | 1.6 |
| Pistachio powder | 8.1 | 8.1 | 8.1 | 8.1 |
| Sucrose | 8.6 | 0.0 | 0.0 | 0.8 |
| Isomaltulose | 0.0 | 4.1 | 2.4 | 2.4 |
| Trehalulose | 0.0 | 4.1 | 2.4 | 2.4 |
| Allulose | 0.0 | 0.0 | 3.3 | 2.4 |
| Isomaltooligosaccharide | 0.0 | 0.5 | 0.5 | 0.5 |
| Cardimom powder | 0.2 | 0.2 | 0.2 | 0.2 |
| Saffron crushed (strands) | 0.02 | 0.0 | 0.0 | 0.0 |
| Total | 100 | 100 | 100 | 100 |
| Calories | 34 | 34 | 21 | 25 |
| GI | 65 | 34 | 21 | 27 |
| GL | 6 | 3 | 2 | 2 |
| Sweetness | 9 | 5 | 5 | 5 |

### Example 20: Malai Peda

The composition of the is shown in Table 20.

TABLE 20

| | Control | Ex 1 | Ex 2 | Ex 3 |
|---|---|---|---|---|
| Ingredients | (%) | (%) | (%) | (%) |
| Full Cream Milk | 48.6 | 48.6 | 48.6 | 48.6 |
| Condensed Milk | 16.2 | 16.2 | 16.2 | 16.2 |
| Corn Flour | 0.8 | 0.8 | 0.8 | 0.8 |
| Lemon extract | 0.4 | 0.4 | 0.4 | 0.4 |
| Sucrose | 24.7 | 0.0 | 0.0 | 4.1 |
| Isomaltulose | 0.0 | 12.2 | 8.1 | 8.1 |
| Trehalulose | 0.0 | 12.2 | 8.1 | 8.1 |
| Allulose | 0.0 | 0.0 | 8.1 | 4.1 |
| Isomaltooligosaccharide | 0.0 | 0.4 | 0.4 | 0.4 |
| Ghee/Butter | 0.8 | 0.8 | 0.8 | 0.8 |
| Cardamom Powder | 0.1 | 0.1 | 0.1 | 0.1 |
| Saffron Color (drops) | 0.2 | 0.2 | 0.2 | 0.2 |
| Water | 8.1 | 8.1 | 8.1 | 8.1 |
| Total | 100 | 100 | 100 | 100 |
| Calories | 99 | 98 | 67 | 83 |
| GI | 65 | 34 | 23 | 33 |
| GL | 16 | 8 | 5 | 8 |
| Sweetness | 25 | 14 | 15 | 16 |

### Example 21: Doodh Peda

The composition of the is shown in Table 21.

TABLE 21

| | Control | Ex 1 | Ex 2 | Ex 3 |
|---|---|---|---|---|
| Ingredients | (%) | (%) | (%) | (%) |
| Milk Powder | 48.8 | 48.8 | 48.8 | 48.8 |
| Unsalted Butter | 2.0 | 2.0 | 2.0 | 2.0 |
| Full Cream Milk | 19.5 | 19.5 | 19.5 | 19.5 |
| Sucrose | 20.0 | 0.0 | 0.0 | 4.9 |
| Isomaltulose | 0.0 | 9.8 | 7.3 | 4.9 |
| Trehalulose | 0.0 | 9.8 | 7.3 | 4.9 |
| Allulose | 0.0 | 0.0 | 4.9 | 4.9 |
| Isomaltooligosaccharide | 0.0 | 0.5 | 0.5 | 0.5 |
| Cardimom Powder | 0.05 | 0.05 | 0.05 | 0.05 |
| Water | 9.8 | 9.8 | 9.8 | 9.8 |
| Total | 100 | 100 | 100 | 100 |
| Calories | 80 | 79 | 61 | 61 |
| GI | 65 | 34 | 25 | 33 |
| GL | 13 | 7 | 5 | 6 |
| Sweetness | 20 | 11 | 12 | 14 |

### Example 22: Kaju Barfi

The composition of the is shown in Table 22.

TABLE 22

| | Control | Ex 1 | Ex 2 | Ex 3 |
|---|---|---|---|---|
| Ingredients | (%) | (%) | (%) | (%) |
| Dried Cashewnuts powder | 11.9 | 11.9 | 11.9 | 11.9 |
| Khoya | 39.8 | 39.8 | 39.8 | 39.8 |
| Sucrose | 40.2 | 0.0 | 0.0 | 8.0 |
| Isomaltulose | 0.0 | 19.9 | 15.9 | 11.9 |
| Trehalulose | 0.0 | 19.9 | 15.9 | 11.9 |
| Allulose | 0.0 | 0.0 | 8.0 | 8.0 |
| Isomaltooligosaccharide | 0.0 | 0.4 | 0.4 | 0.4 |
| Cardimom Powder | 0.04 | 0.04 | 0.04 | 0.04 |
| Water | 8.0 | 8.0 | 8.0 | 8.0 |
| Silver foil | 0.1 | 0.1 | 0.1 | 0.1 |
| Total | 100 | 100 | 100 | 100 |
| Calories | 161 | 160 | 130 | 130 |
| GI | 65 | 34 | 27 | 33 |
| GL | 26 | 13 | 11 | 13 |
| Sweetness | 40 | 22 | 23 | 27 |

### Example 23: Ras Malai

The composition of the is shown in Table 24.

TABLE 23

| | Control | Ex 1 | Ex 2 | Ex 3 |
|---|---|---|---|---|
| Ingredients | (%) | (%) | (%) | (%) |
| Chena/Paneer | 26.5 | 26.5 | 26.5 | 26.5 |
| Rabadi | 53.0 | 53.0 | 53.0 | 53.0 |
| Sucrose | 20.3 | 0.0 | 0.0 | 2.7 |
| Isomaltulose | 0.0 | 9.9 | 8.0 | 6.6 |
| Trehalulose | 0.0 | 9.9 | 8.0 | 6.6 |
| Allulose | 0.0 | 0.0 | 4.0 | 4.0 |
| Isomaltooligosaccharide | 0.0 | 0.4 | 0.4 | 0.4 |
| Cardamom Powder | 0.01 | 0.01 | 0.01 | 0.01 |
| Saffron color (drops) | 0.1 | 0.1 | 0.1 | 0.1 |
| Total | 100 | 100 | 100 | 100 |
| Calories | 81 | 81 | 65 | 65 |
| GI | 65 | 34 | 27 | 31 |
| GL | 13 | 7 | 5 | 6 |
| Sweetness | 20 | 11 | 12 | 13 |

### Example 24: Patisa (Soan Papdi)

The composition of the is shown in Table 24.

TABLE 24

| | Control | Ex 1 | Ex 2 | Ex 3 |
|---|---|---|---|---|
| Ingredients | (%) | (%) | (%) | (%) |
| Gram Flour | 18.6 | 18.6 | 18.6 | 18.6 |
| Refined Flour/Maida | 18.6 | 18.6 | 18.6 | 18.6 |
| Ghee/Butter | 9.3 | 9.3 | 9.3 | 9.3 |
| Full Cream Milk | 1.9 | 1.9 | 1.9 | 1.9 |
| Sucrose | 22.7 | 0.0 | 0.0 | 3.7 |
| Isomaltulose | 0.0 | 11.2 | 9.3 | 7.5 |
| Trehalulose | 0.0 | 11.2 | 9.3 | 7.5 |
| Allulose | 0.0 | 0.0 | 3.7 | 3.7 |
| Isomaltooligosaccharide | 0.0 | 0.4 | 0.4 | 0.4 |
| Chopped almond, Cheshue, Pista | 0.7 | 0.7 | 0.7 | 0.7 |
| Cardamom seed | 0.1 | 0.1 | 0.1 | 0.1 |
| Water | 28.0 | 28.0 | 28.0 | 28.0 |
| Total | 100 | 100 | 100 | 100 |
| Calories | 91 | 90 | 76 | 76 |
| GI | 65 | 34 | 28 | 33 |
| GL | 15 | 7 | 6 | 7 |
| Sweetness | 23 | 12 | 13 | 15 |

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A low calorie, low glycemic index (GI), and
sustained energy release sugar composition, the composition comprising:
a combination of sugars selected from a group comprising isomaltulose, trehalulose and D-allulose;
at least one of the following: essential trace elements, soluble oligosaccharides and bulking agents; and
optionally, one or more nutritive sweeteners.

2. The low calorie, low glycemic index, and sustained energy release sugar composition as claimed in claim 1, comprising two sugars selected from isomaltulose, trehalulose and allulose.

3. The low calorie, low glycemic index, and sustained energy release sugar composition as claimed in claim 1, wherein the two sugars are isomaltulose and trehalulose.

4. The low calorie, low glycemic index, and sustained energy release sugar composition as claimed in claim 3, wherein the ratio of the isomaltulose to the trehalulose is from about 14:1 to about 1:1 on a weight to weight basis.

5. The low calorie, low glycemic index, and sustained energy release sugar composition as claimed in claim 1, wherein the two sugars are trehalulose and allulose.

6. The low calorie, low glycemic index, and sustained energy release sugar composition as claimed in claim 5, wherein the ratio of the allulose to the trehalulose is from about 0.4:1 to about 17:1 on a weight to weight basis.

7. The low calorie, low glycemic index, and sustained energy release sugar composition as claimed in claim 1, wherein the two sugars are isomaltulose and allulose.

8. The low calorie, low glycemic index, and sustained energy release sugar composition as claimed in claim 7, wherein the ratio of the allulose to the isomaltulose is from about 0.19:1 to about 17:1 on a weight to weight basis.

9. The low calorie, low glycemic index, and sustained energy release sugar composition as claimed in claim 1, comprising isomaltulose, trehalulose and allulose; wherein the ratio of the isomaltulose to the trehalulose is from about 14:1 to about 1:1; allulose to the trehalulose is from about 0.4:1 to about 17:1, and allulose to the trehalulose is from about 0.19:1 to about 17:1 on a weight to weight basis.

10. The low calorie, low glycemic index, and sustained energy release sugar composition as claimed in claim 1, wherein the essential trace element is present in an amount of from about 0.01% to about 1% by weight relative to the total weight of the composition.

11. The low calorie, low glycemic index, and sustained energy release sugar composition as claimed in claim 1, wherein the soluble oligosaccharides are present in an amount of from about 0.01% to about 1% by weight relative to the total weight of the composition.

12. The low calorie, low glycemic index, and sustained energy release sugar composition as claimed in claim 1, wherein nutritive sweetener is selected from a group comprising sucrose and invert sugar.

13. A composition comprising:
(a) a low calorie, a low glycemic index, and sustained energy release sugar composition comprising a combination of sugars selected from a group comprising isomaltulose, trehalulose and allulose;
(b) at least one of the following: essential trace elements, soluble oligosaccharides and bulking agents;
(c) optionally, one or more nutritive sweeteners; and
(d) an edible component;
wherein the edible component is a food or beverage and the sugars are present in a combined total amount of from about 5% to about 80% by weight relative to the total weight of the composition.

14. The composition as claimed in claim 13, wherein the low calorie, low glycemic index, and sustained energy release sugar composition comprises two sugars selected from isomaltulose, trehalulose and allulose in a combined total amount of from about 5% to about 80% by weight relative to the total weight of the composition.

15. The composition as claimed in claim 13, wherein the essential trace element is present in an amount of from about 0.01% to about 1% and soluble oligosaccharides are present in an amount of from about 0.01% to about 1% by weight relative to the total weight of the composition.

16. The composition as claimed in claim 13, wherein the nutritive sweetener is selected from a group comprising sucrose and invert sugar.

17. A food or beverage product selected from the group consisting of: a bread product comprising low calorie, low glycemic index, and sustained energy release sugar composition, comprising isomaltulose in an amount from 0% to about 30%, trehalulose in an amount of from about 0% to about 30% and allulose in an amount of from about 0% to about 30% by weight relative to the total weight of the uncooked bread product; wherein isomaltulose, trehalulose and allulose are not 0% simultaneously;
a confectionary product comprising low calorie, low glycemic index, and sustained energy release sugar composition, comprising isomaltulose in an amount from 0% to about 75%, trehalulose in an amount of from about 0% to about 75% and allulose in an amount of from about 0% to about 75% by weight relative to the total weight of the uncooked confectionary product; wherein isomaltulose, trehalulose and allulose are not 0% simultaneously;
a non-carbonated beverage comprising low calorie, low glycemic index, and sustained energy release sugar composition comprising isomaltulose in an amount from about 0% to about 15%, trehalulose in an amount from about 0% to about 15% and trehalulose in an amount of from about 0% to about 15% by weight relative to the total weight of the beverage; wherein isomaltulose, trehalulose and allulose are not 0% simultaneously;
a frozen dessert comprising low calorie, low glycemic index, and sustained energy release sugar composition comprising isomaltulose in an amount of from about 0% to about 30%, trehalulose in an amount of from about 0% to about 30% and allulose in an amount of from about 0% to about 30% by weight relative to the total weight of the dessert; wherein isomaltulose, trehalulose and allulose are not 0% simultaneously;
a yogurt comprising low calorie, low glycemic index, and sustained energy release sugar composition comprising isomaltulose in an amount of from about 0% to about 50%, trehalulose in an amount of from about 0% to about 50% and allulose in an amount of from about 0% to about 50% by weight relative to the total weight of the yogurt; wherein isomaltulose, trehalulose and allulose are not 0% simultaneously;
a sweet bakery product comprising low calorie, low glycemic index, and sustained energy release sugar composition comprising isomaltulose in an amount of from about 0% to about 40%, trehalulose in an amount of from about 0% to about 40% and allulose in an amount of from about 0% to about 40% by weight relative to the total weight of the uncooked product; wherein isomaltulose, trehalulose and allulose are not 0% simultaneously;
a snack bar comprising low calorie, low glycemic index, and sustained energy release sugar composition comprising isomaltulose in an amount of from about 0% to about 30%, trehalulose in an amount of from about 0% to about 30% and allulose in an amount of from about 0% to about 30% by weight relative to the total weight of the snack bar; wherein isomaltulose, trehalulose and allulose are not 0% simultaneously;
a carbonated beverage comprising low calorie, low glycemic index, and sustained energy release sugar composition comprising isomaltulose in an amount of from about 0% to about 70%, trehalulose in an amount of from about 0% to about 70% and allulose in an amount of from about 0% to about 70% by weight relative to the total weight of carbonated beverage; wherein isomaltulose, trehalulose and allulose are not 0% simultaneously; and
an Indian sweet comprising low calorie, low glycemic index, and sustained energy release sugar composition comprising isomaltulose in an amount of from about 0% to about 60%, trehalulose in an amount of from about 0% to about 60% and allulose in an amount of from about 0% to about 60% by weight relative to the total weight of the uncooked product; wherein isomaltulose, trehalulose and allulose are not 0% simultaneously.

18-28. (canceled)

29. A table-top sugar comprising low calorie, low glycemic index, and sustained energy release sugar composition comprising isomaltulose in an amount of from about 0% to about 70%, trehalulose in an amount of from about 0% to about 50% and allulose in an amount of from about 0% to about 85% by weight relative to the total weight of isomaltulose, trehalulose and allulose in the table-top sugar; wherein isomaltulose, trehalulose and allulose are not 0% simultaneously.

30. The table-top sugar as claimed in claim 29, comprising isomaltulose in an amount of from about 0% to about 70%, trehalulose in an amount of from about 0% to about 50% and allulose in an amount of from about 10% by weight relative to the total weight of isomaltulose, trehalulose and allulose in the table-top sugar.

31. The table-top sugar as claimed in claim 29, further comprising at least one essential trace element in an amount from about 0.02% to about 0.05% by weight relative to the total weight of the sugar and, optionally, one or more soluble oligosaccharides and nutritive sweeteners.

32-45. (canceled)
